(19) United States
(12) Patent Application Publication
(10) Pub. No.: US 2019/0268685 A1
(43) Pub. Date: Aug. 29, 2019

(54) GUN MICROPHONE WIND SHIELD

(71) Applicant: TOMOEGAWA CO., LTD., Tokyo (JP)

(72) Inventors: Fukushi KAWAKAMI, Hamamatsu-shi, Shizuoka (JP); Takayuki SANO, Shizuoka-shi, Shizuoka (JP)

(21) Appl. No.: 16/088,384

(22) PCT Filed: Feb. 14, 2017
(86) PCT No.: PCT/JP2017/005382

§ 371 Date: Sep. 25, 2018

(30) Foreign Application Priority Data
Mar. 29, 2016 (JP) 2016-065177

(51) Int. Cl. H04R 1/08; H04R 1/32

(52) U.S. Cl. CPC H04R 1/083; H04R 1/326

(57) ABSTRACT

This invention provides a gun microphone wind shield to which a grip member can be easily attached and which maintains the function as a wind shield.

There is provided a gun microphone wind shield includes: a first covering body that covers a gun microphone, has an elongated shape, and contains an acoustic transmissive material; a second covering body that covers the first covering body, has an elongated shape, and is formed from an elastic foaming body with open cells; and a hold portion that engages with the second covering body and is held in a predetermined position on the second covering body. The acoustic transmissive material includes a fiber material obtained by interlacing a raw material containing fibers.

### TECHNICAL FIELD

The present invention relates to a wind shield used for a gun microphone with directivity.

### BACKGROUND ART

Gun microphones (shot-gun microphones) are used in many cases to pick up sounds at a long distance. The gun microphone has high directivity and can pick up sounds ahead of the gun microphone while canceling out surrounding sounds.

In general, the gun microphone has a narrow and elongated columnar interference tube. The gun microphone can pick up mainly sounds ahead of the gun microphone by interfering with sounds emitted from a sound source positioned on the lateral sides of the gun microphone to cancel out the sounds in the interference tube.

As described above, the gun microphone has an elongated interference tube. Accordingly, when wind noise such as whistling sounds is picked up by the gun microphone, the entire gun microphone including the interference tube needs to be covered with a wind shield.

As one of conventional wind shields, there is a wind shield in which an almost cylindrical sponge has fibers implanted in the internal diameter side. This wind shield is designed to be hard to come off an elongated macrophone due to the implanted fibers (for example, refer to Patent Literature 1).

There is also a wind shield with a cage-shaped frame. The cage-shaped frame forms a space from an elongated microphone and supports the wind shield (for example, refer to Patent Literature 2).

These sponge-like wind shield and cage-like frame-equipped wind shield are intended to reduce wind noise. Accordingly, when some shock or the like is applied to the microphone, the diaphragm vibrates due to the shock and the microphone picks up the sound derived from the shock as a noise. Thus, these wind shields cannot sufficiently handle with the shock.

To handle with shock or the like, there is a device for holding a macrophone via a suspension (for example, refer to Patent Literature 3). This device dampens shock with the suspension to make the shock less likely to transfer to the macrophone.

### CITATION LIST

### Patent Literatures

Patent Literature 1: JP 2006-60479 A

Patent Literature 2: JP 2012-175379 A

Patent Literature 3: GB2529069 specification

### SUMMARY OF INVENTION

### Technical Problem

As described above, wind shields without a suspension cannot sufficiently dampen applied impact. In addition, in the suspension-equipped wind shield, the suspension sandwiches the wind shield therein. Accordingly, the detachment of the suspension is troublesome, and the mechanism of the suspension needs to be provided on not only the outside of the wind shield but also partially the inside of the wind shield. This reduces the volumetric capacity of the wind shield and disables the smooth movement of the air in the wind shield, which inevitably deteriorates the function of the wind shield.

The present invention is devised in light of the foregoing points. An object of the present invention is to provide a gun microphone wind shield that allows easy attachment of a grip member and maintains the function of the wind shield.

### Solution to Problem

An aspect of a gun microphone wind shield according to the present invention includes: a first covering body that covers a gun microphone (for example, such as a gun microphone 300 described later or the like), has an elongated shape, and contains an acoustic transmissive material (for example, a first acoustic transmissive body 160 described later or the like); a second covering body that convers the first covering body, has an elongated shape, and is made from an elastic foaming body with open cells (for example, an outer enclosure 110 described later or the like); and a hold portion that engages with the second covering body and is held in a predetermined position on the second covering body (for example, a vibration-proof hold portion 120 described later or the like), wherein the acoustic transmissive material is obtained by interlacing a raw material containing fibers.

The second covering body covers the first covering body for covering the gun microphone. The second covering body is formed from the elastic foaming body with open cells. The second covering body constitutes a vibration-proof structure. Even if shock is applied to the hold portion, the second covering body absorbs the shock to prevent the shock from being picked up as noise by the gun microphone.

The hold portion is configured to be engaged with the second covering body so that the hold body can be easily attached to the second covering body.

### Advantageous Effects of Invention

The grip member can be easily attached to the wind shield while the function of the wind shield is maintained.

### BRIEF DESCRIPTION OF DRAWINGS

FIG. 1 is a side view (FIG. 1A) and cross-sectional views (FIGS. 1B and 1C) of an outline of a gun microphone wind shield 100 according to a first embodiment.

FIG. 2 is a side view of the entire gun microphone wind shield 100.

FIG. 3 is an exploded perspective view of an outer enclosure 110 and a vibration-proof hold portion 120 of the gun microphone wind shield 100.

FIG. 4 is a perspective view of the outer enclosure 110 constituting the gun microphone wind shield 100, a first acoustic transmissive body 160, a microphone hold portion 140, and a gun microphone 300.

FIG. 5 is an enlarged perspective view of a second end 116b of a cylindrical portion 114, the microphone hold portion 140, and the gun microphone 300.

FIG. 6 is a cross-sectional view of the gun microphone wind shield 100 taken along a circumferential direction.

FIG. 7 is a perspective view of a structure of the microphone hold portion 140.

FIG. 8 is a perspective view of the microphone hold portion 140 to which the gun microphone 300 is attached.

FIG. 9 is a cross-sectional view (FIG. 9A) of longitudinal flows of air and is a cross-sectional view (FIG. 9B) of circumferential flows of air in a first space SP10 and a second space SP20.

FIG. 10 is a perspective view of a configuration of a gun microphone wind shield 200 according to a second embodiment.

FIG. 11 is a perspective view of a first acoustic transmissive body 160 and a second acoustic transmissive body 260 according to the second embodiment.

FIG. 12 is a perspective view of an elastic hold body 240 provided between the first acoustic transmissive body 160 and the second acoustic transmissive body 260 according to the second embodiment.

FIG. 13 is a cross-sectional view (FIG. 13A) of longitudinal flows of air and is a cross-sectional view (FIG. 13B) of circumferential flows of air in a third space SP30 and a second space SP20.

FIG. 14 is a perspective view of a configuration of a gun microphone wind shield 100 according to a third embodiment.

FIG. 15 is a perspective view of a first acoustic transmissive body 160 and a gun microphone 300 according to the third embodiment.

FIG. 16 is a perspective view of an elastic hold body 270 provided between the first acoustic transmissive body 160 and the gun microphone 300 according to the third embodiment.

FIG. 17 is a cross-sectional view (FIG. 17A) of longitudinal flows of air and is a cross-sectional view (FIG. 17B) of circumferential flows of air in a first space SP10 and a second space SP20 according to the third embodiment.

FIG. 18 is an exploded perspective view of an outer enclosure 110, a vibration-proof hold portion 120, and a sheet-like wind shield enclosure 180 of the gun microphone wind shield 100 according to a second modification example.

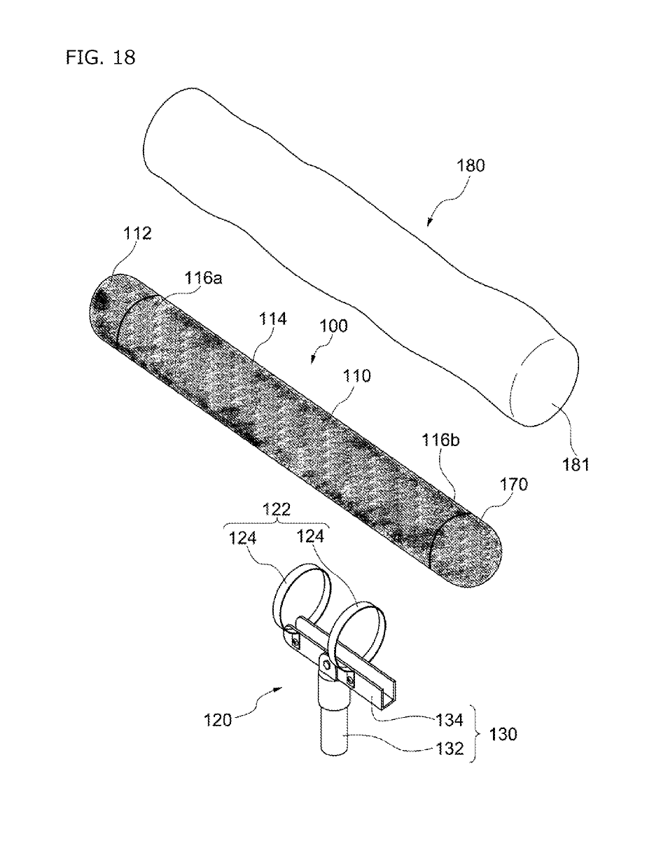

FIG. 19 is a side view of an entire gun microphone wind shield 100 according to the second modification example.

### DESCRIPTION OF EMBODIMENTS

Embodiments will be described below with reference to the drawings.

### First Aspect

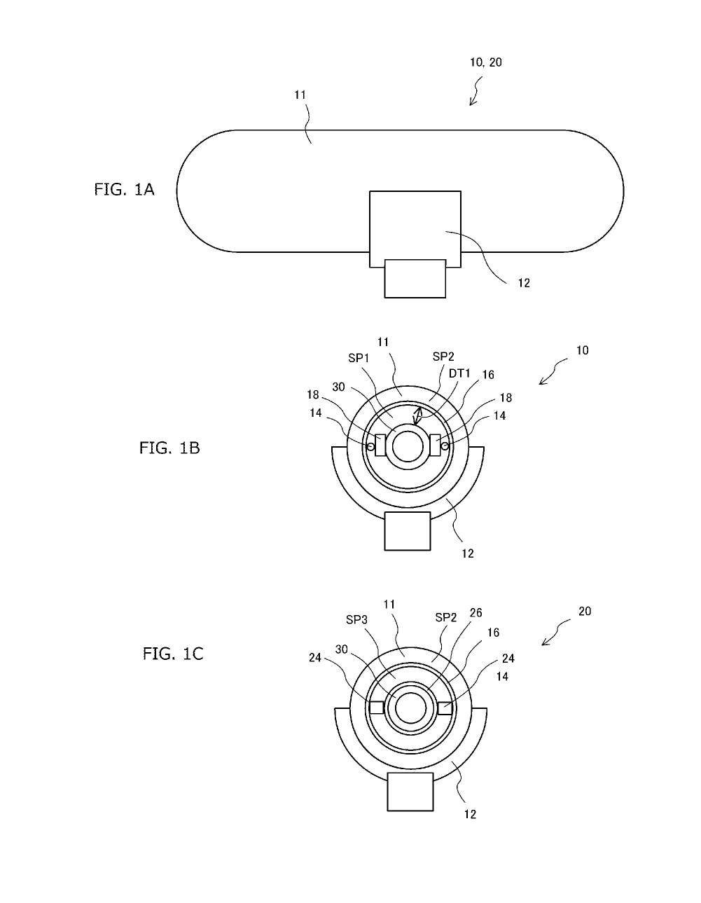

As illustrated in FIGS. 1A to 1C, according to a first aspect of the present invention, there is provided a gun microphone wind shield 10 or 20 that includes: a first covering body 16 that covers a gun microphone 30 (for example, such as a gun microphone 300 described later or the like), has an elongated shape, and contains an acoustic transmissive material (for example, a first acoustic transmissive body 160 described later or the like); a second covering body 11 that convers the first covering body 16, has an elongated shape, and is formed from an elastic foaming body with open cells (for example, an outer enclosure 110 described later or the like); and a hold portion 12 that engages with the second covering body 11 and is held in a predetermined position on the second covering body 11 (for example, a vibration-proof hold portion 120 described later or the like), wherein the acoustic transmissive material includes a fiber material that is obtained by interlacing a raw material containing fibers.

### Gun Microphone Wind Shields 10 and 20 and Gun Microphone 30

The gun microphone wind shields 10 and 20 are wind shields for covering the gun microphone 30. The gun microphone 30 is a microphone with directivity for picking up sounds emitted from a sound source. The gun microphone 30 has an interference tube or the like and is generally elongated in shape. The gun microphone wind shields 10 and 20 include the first covering body 16, the second covering body 11, and the hold portion 12.

### Acoustic Transmissive Material

The first covering body 16 includes an acoustic transmissive material. The acoustic transmissive material includes a fiber material. The fiber material is obtained by interlacing a raw material containing fibers. The acoustic transmissive material blocks part of contacting air and transmits the remainder of the air. The acoustic transmissive material makes it possible to shut off wind noise such as whistling sounds. The ingredients and substances of the acoustic transmissive material can be decided in such a manner as to shut off wind noise appropriately and pick up sounds emitted from a sound source properly. In addition, the acoustic transmissive material is less susceptive to moisture such as humidity to prevent aged deterioration of acoustic characteristics caused by moisture and the like.

### First Covering Body 16

The first covering body 16 covers the gun microphone 30. The gun microphone 30 is generally elongated in shape and has an interferential opening along a longitudinal direction. The first covering body 16 needs to cover the gun microphone 30 in such a manner as to overlap at least part of the interferential opening. The first covering body 16 preferably covers the gun microphone 30 so as to overlap the entire interferential opening. The shape of the first covering body 16 can be decided according to the elongated shape of the gun microphone 30.

The longitudinal length of the first covering body 16 is preferably larger than the longitudinal length of the gun microphone 30. This makes it possible to provide an air layer ahead of the gun microphone 30 in the direction of the sound source, thereby reducing wind noise reliably. For example, the longitudinal length of the first covering body 16 is preferably set such that a length equal to or larger than the diameter of the gun microphone 30 is added to the longitudinal length of the gun microphone 30. The first covering body 16 preferably covers the gun microphone 30 in such a manner as to store the entire gun microphone 30 except for a cable and the like connected to the gun microphone 30. Further, the first covering body 16 is desirably concentric (coaxial) to the gun microphone 30 to cover the entire gun microphone 30. In particular, a high-performance wind shield for shutting off or reducing solid propagation components of wind noise needs to be configured so as not to generate even a slight air gap.

The first covering body 16 is desirably almost circular cylindrical in shape. Further, the first covering body 16 is not limited to an almost circular cylindrical shape but may have any of various cylindrical shapes such as a square cylinder or an elliptic cylinder. The shape of the first covering body 16 can be decided according to the elongated shape of the gun microphone 30.

As illustrated in FIG. 1B, the first covering body 16 is arranged in a position separated from the gun microphone 30. A first space SP1 is formed by the gap between the first covering body 16 and the gun microphone 30. A distance DT1 between the first covering body 16 and the gun microphone 30 may not be constant.

The distance DT1 is only required to shut off wind noise by forming the first space SP1 between the first covering body 16 and the gun microphone 30 and moving the air in the first space SP1. Arranging the first covering body 16 to be concentric (coaxial) to the gun microphone 30 makes the distance DT1 constant. Making the distance DT1 constant between the first covering body 16 and the gun microphone 30 allows the air having entered the first space SP1 to be dispersed evenly in the first space SP1.

### Second Covering Body 11

The second covering body 11 covers the first covering body 16. The second covering body 11 has an elongated shape. The second covering body 11 preferably covers the entire first covering body 16.

The second covering body 11 is made of an elastic foaming body with open cells. The elastic foaming body has open cells. The elastic foaming body can control the direction of a flow of air by the open cells, or block and slow down a flow of air gradually by collision with the open cells. In this way, the elastic foaming body can suppress the direction and velocity of the air having entered the second covering body 11.

The second covering body 11 defines a second space SP2. The second covering body 11 controls a flow of air in the second space SP2.

The second covering body 11 is formed from an elastic foaming body and is elastically deformable in every portion. Accordingly, even when external shock or the like is applied or wind noise is propagated as solid-borne sounds, the second covering body 11 repeats elastic deformation and recovery to absorb or reduce the shock gradually. The elastic foaming body of the second covering body 11 constitutes a vibration-proof structure. The vibration-proof structure of the second covering body 11 absorbs externally applied shock or the like to make the shock less likely to transfer to the gun microphone 300 and prevent the shock from being picked up as noise. The elastic coefficient and the like of the second covering body 11 can be decided as appropriate according to the material and thickness of the second covering body 11 and the area of contact with the hold portion 12. To obtain the vibration-proof effect in the voice band (20 Hz to 20 kHz), for example, the elastic coefficient is decided so that resonance frequency f₀ of the spring-mass system is 10 Hz or less.

Further, the second covering body 11 is formed from a sponge-like elastic foaming body with open cells and has porous properties, for example. Forming the second covering body 11 from an elastic foaming body makes it easy to catch (stop) the surface of the second covering body 11 on the hold portion 12 described later, whereby the second covering body 11 can be easily engaged with the hold portion 12. The surface of the second covering body 11 can be formed in any mode as far as the hold portion 12 can engage with the second covering body 11 and is less likely to come off the second covering body 11.

### Hold Portion 12

The hold portion 12 engages with the second covering body 11 to be held in a predetermined position on the second covering body 11. For example, when the surface of the second covering body 11 has asperities, the second covering body 11 can be easily caught on the hold portion 12. This prevents the hold portion 12 from coming off the second covering body 11. Further, the hold portion 12 may be provided with an additional adjustment mechanism of a bolt and a nut to adjust the effective diameter in the optimum engagement state.

The hold portion 12 can be held by the user's hand and thus may be subjected to shock during the use. As described above, the second covering body 11 constitutes a vibration-proof structure. Even if shock is applied to the hold portion 12, the second covering body 11 absorbs the shock to prevent the shock from being picked up as noise by the gun microphone 30.

The hold portion 12 is configured to be engaged with the second covering body 11 so that the hold portion 12 can be easily attached to the second covering body 11.

### First Space SP1 and Second Space SP2

The air having passed through the surface of the second covering body 11 then enters the second space SP2. The air having entered the second space SP2 then enters the elastic foaming body. The elastic foaming body has open cells and the air having entered the elastic foaming body moves along the open cells. The elastic foaming body can control the flowing direction of the air. The flow of the air can be interfered and slowed down gradually by collision with the open cells. In this way, the elastic foaming body can suppress the velocity of the air.

Further, the air having entered the second space SP2 gradually slows down by contact with the first covering body 16. Accordingly, the momentum of the air can be suppressed.

The second space SP2 (elastic foaming body) acts as a buffer region for gradually slowing down the incoming air. Therefore, the air is less likely to pass through the first covering body 16. However, the air may pass through the first covering body 16 depending on the use environment of the gun microphone 30. When having passed through the first covering body 16, the air then also enters the first space SP1.

### First Space SP1

The first space SP1 has a longitudinal flow path and a circular flow path. The longitudinal flow path is a path in which the air having flowed into the first space SP1 moves along the longitudinal direction of the first space SP1. The first space SP1 has an elongated shape and acts as a region for facilitating the movement of the air in the longitudinal direction. Moving the air in the longitudinal direction makes it possible to slow down the air gradually and prevent wind noise such as whistling sounds from being picked up by the gun microphone 30.

The circular flow path is a path in which the air having flowed into the first space SP1 moves along the direction that circles around the gun microphone 30. The circular flow path acts as a region for facilitating the movement of the air in the circling direction. Moving the air in the circling direction makes it possible to slow down the air gradually.

The gun microphone wind shield 10 acts as a wind shield with the formation of the first space SP1 and the second space SP2. Further, this configuration allows the second covering body 11 to act both as a wind shield layer and a vibration-proof system.

### Second Aspect

In a second aspect of the present invention, the hold portion 12 in the first aspect has a surface engagement portion to engage with the surface of the second covering body 11 (for example, an annular member 124 described later or the like).

As described above, the second covering body 11 is formed from a sponge-like elastic foaming body with open cells and has porous properties, for example. The surface of the second covering body 11 preferably has asperities. With the asperities on the surface, the second covering body 11 can be easily supported/caught on the hold portion 12, whereby the second covering body 11 can easily engage with the hold portion 12.

### Third Aspect

In a third aspect of the present invention, the hold portion 12 in the first aspect of the present invention has a circling engagement portion that circles around the second covering body 11 and engages with the second covering body 11 (for example, the annular member 124 described later or the like).

The hold portion 12 has the circling engagement portion that circles around the second covering body 11 and engages with the second covering body 11, which increases the area of contact with the second covering body 11 and allows the hold portion 12 to contact the entire perimeter of the second covering body 11. Even if the second covering body 11 is displaced (rotated) in a circumferential direction, it is possible to maintain the state of being caught on the hold portion 12 and make the hold portion 12 less likely to come off the second covering body 11.

### Fourth Aspect

As illustrated in FIG. 1B, a fourth aspect of the present invention according to the first aspect of the present invention further includes a microphone hold body 14 that has an elongated shape, holds the gun microphone 30 in a manner of being capable of sound transmission, is stored in the first covering body 16, and holds the gun microphone 30 in a position separated from the first covering body 16 (for example, a microphone hold portion 140 described later or the like), wherein the first covering body has a storage portion in which the microphone hold body is stored (for example, the inside of a first acoustic transmissive body 160 described later or the like).

The microphone hold body 14 holds the gun microphone 30 in a position separated from the first covering body 16, which makes it possible to form the first space SP1 constantly between the first covering body 16 and the gun microphone 30. Forming the first space SP1 makes it possible to form the longitudinal flow path and the circular flow path in a stable manner. Accordingly, the air having entered the first space SP1 can be dispersed and gradually slow down in the first space SP1.

### Fifth Aspect

As illustrated in FIG. 1B, in a fifth aspect of the present invention according to the fourth aspect of the present invention, the microphone hold body 14 has a hold member 18 (for example, a hold member 158 described later or the like) elastically deformable by contact with the gun microphone.

The hold member 18 is elastically deformable by contact with the gun microphone. Thus, even if external shock is applied, the hold member 18 can absorb the shock and make the shock less likely to transfer to the gun microphone 30, thereby preventing the shock from being picked up as noise. The vibration-proof structure of the second covering body 11 described above first absorbs the shock and then the hold member 18 also absorbs the shock. In this way, it is possible to dampen the shock in the two steps.

### Sixth Aspect

As illustrated in FIG. 1C, a sixth aspect of the present invention according to the first aspect of the present invention further includes a third covering body 26 (for example, a second acoustic transmissive body 260 described later or the like) that is capable of holding the gun microphone 30, has an elongated shape, contains an acoustic transmissive material, is stored in the first covering body 16, and is held in a position separated from the first covering body 16.

The third covering body 26 has an elongated shape. The third covering body 26 contains an acoustic transmissive material. The third covering body 26 can further shut off wind noise such as whistling sounds.

In addition, the third covering body 26 can hold the gun microphone 30. This makes it possible to hold the gun microphone 30 without the use of a member for holding the gun microphone 30, which simplifies the configuration of the gun microphone wind shield 20. In particular, configuring the gun microphone 30 in a detachably attachable manner allows the gun microphone 30 to be easily attached and detached.

The third covering body 26 is held in a position separated from the first covering body 16. Separately from the second space SP2, a third space SP3 is formed between the first covering body 16 and the third covering body 26. The second space SP2 acts as described above. The air may pass through the first covering body 16 depending on the use environment of the gun microphone 30. When having passed through the first covering body 16, the air also enters the third space SP3.

The third space SP3 has a longitudinal flow path and a circular flow path. The longitudinal flow path is a path in which the air having flowed into the third space SP3 moves along the longitudinal direction of the third space SP3. The third space SP3 has an elongated shape and acts as a region for facilitating the movement of the air in the longitudinal direction. Moving the air in the longitudinal direction makes it possible to slow down the air gradually and prevent wind noise such as whistling sounds from being picked up by the gun microphone 30.

The circular flow path is a path in which the air having flowed into the third space SP3 moves along the direction that circles around the third covering body 26. The circular flow path acts as a region for facilitating the movement of the air in the circling direction. Moving the air in the circling direction makes it possible to slow down the air gradually.

The third covering body 26 can form the third space SP3 to further enhance the effect of shutting off wind noise. Further, the third covering body 26 allows the gun microphone 30 to be easily attached and held.

### Seventh Aspect

As illustrated in FIG. 1C, a seventh aspect of the present invention according to the sixth aspect of the present invention further includes a hold member 24 (for example, an elastic hold body 240 described later or the like) that holds the third covering body 26, is arranged between the first covering body 16 and the third covering body 26, and is formed from an elastic foaming body with open cells.

Holding the third covering body 26 in a position separated from the first covering body 16 by the hold member 24 makes it possible to form uniformly the third space SP3 between the first covering body 16 and the third covering body 26. Forming the third space SP3 makes it possible to form the longitudinal flow path and the circular flow path in a stable manner. Accordingly, the air having entered the third space SP3 can be dispersed and gradually and properly slow down in the third space SP3.

The hold member 24 is formed from an elastic foaming body with open cells and is elastically deformable. Accordingly, even if external shock is applied, the hold member 24 can absorb the shock and make the shock less likely to transfer to the gun microphone 30, thereby preventing the shock from being picked up as noise. The vibration-proof structure of the second covering body 11 described above first absorbs shock and solid-borne sounds, and then the hold member 24 also absorbs them. In this way, it is possible to dampen shock and wind noise in the two steps.

### FIRST EMBODIMENT

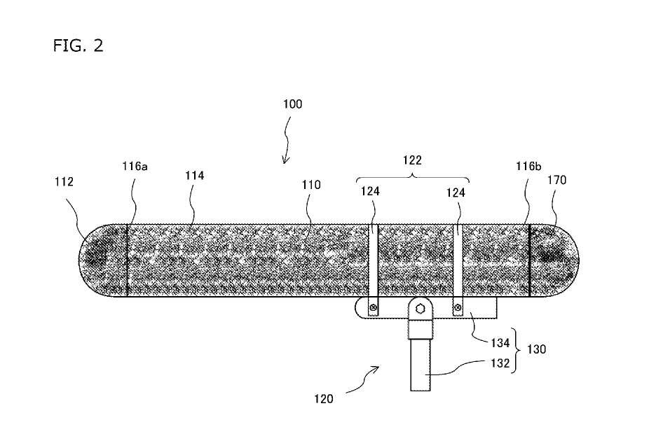

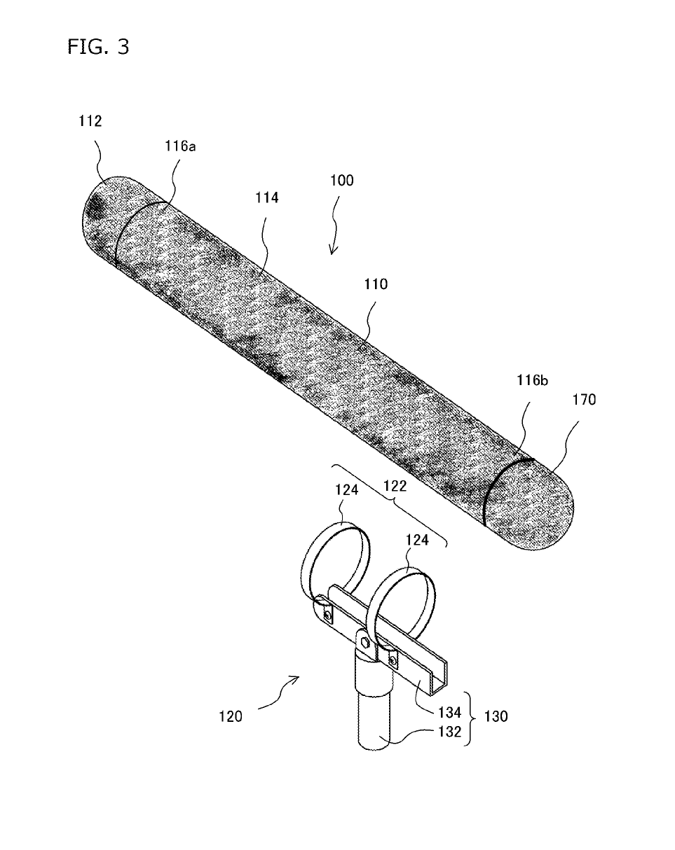

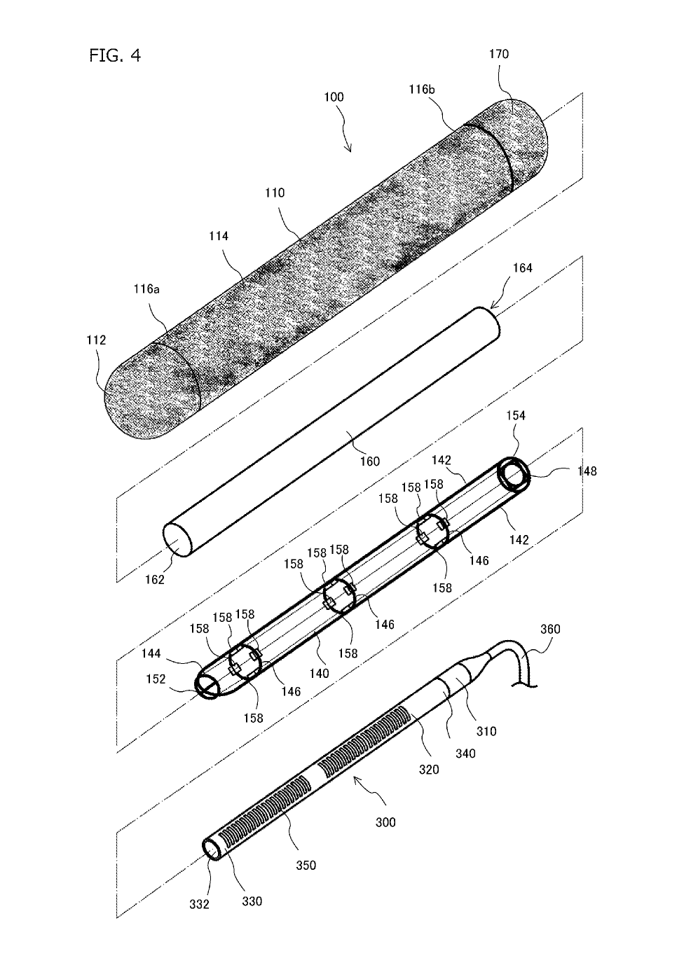

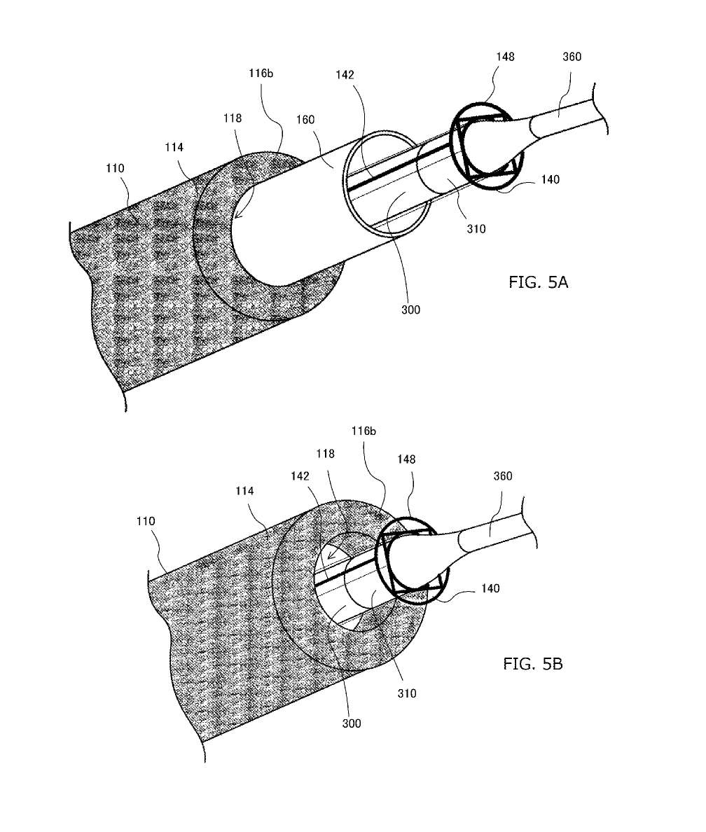

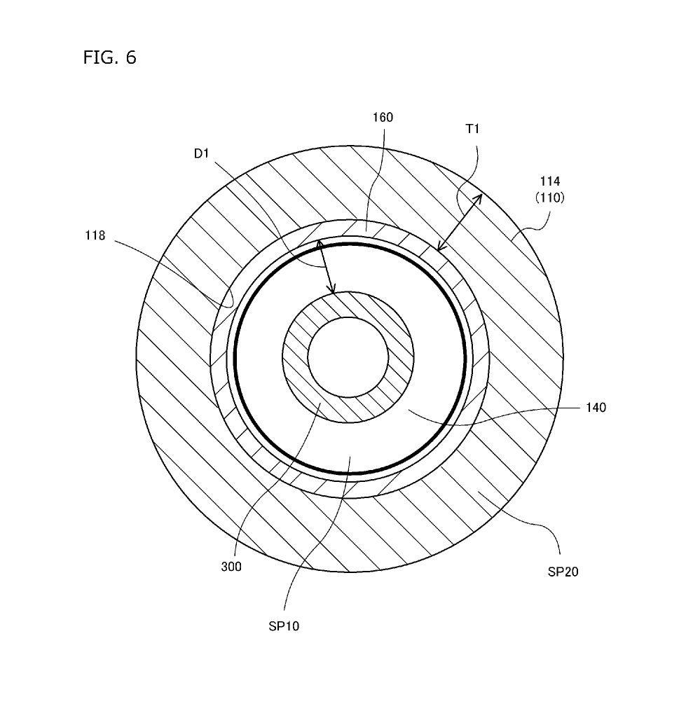

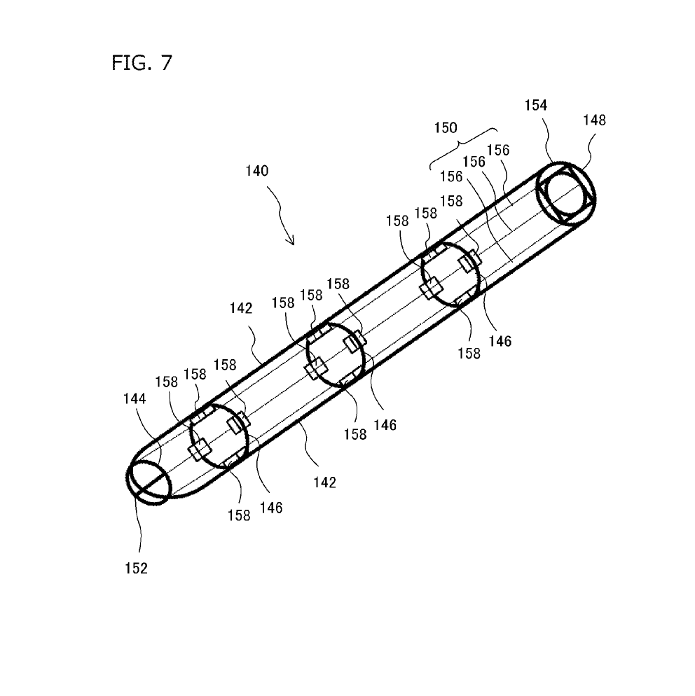

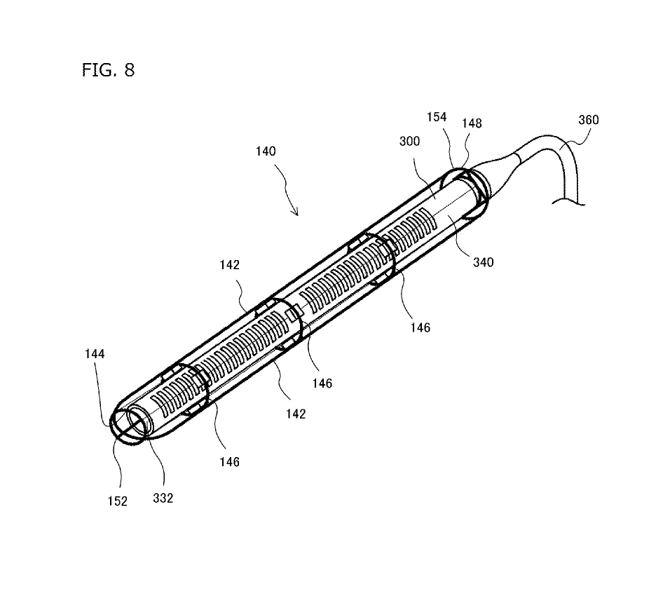

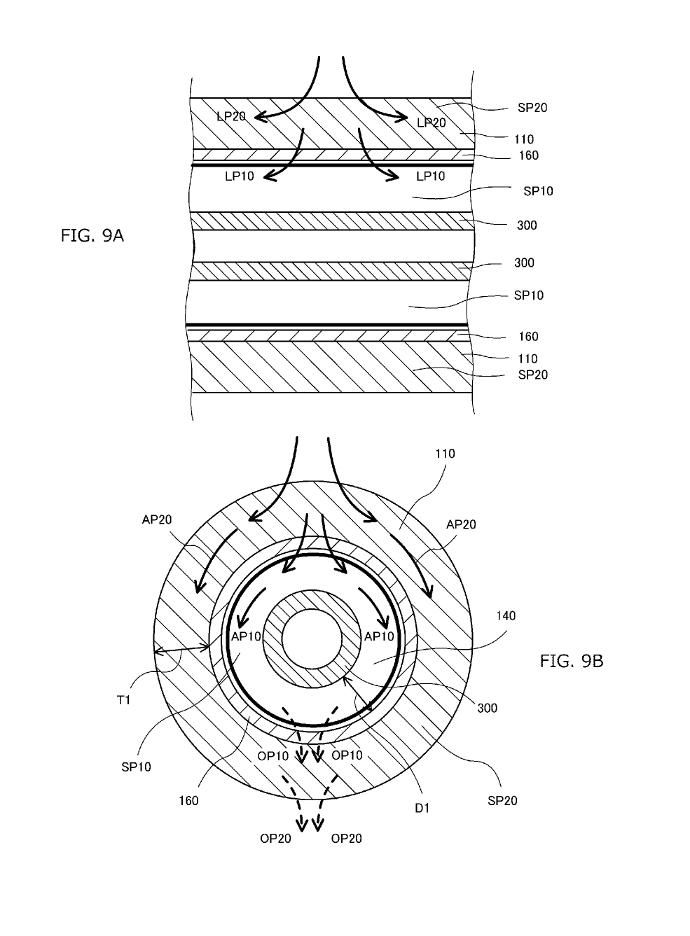

FIG. 2 is a side view of an entire gun microphone wind shield 100. FIG. 3 is an exploded perspective view of an outer enclosure 110 and a vibration-proof hold portion 120 of the gun microphone wind shield 100. FIG. 4 is a perspective view of the outer enclosure 110 constituting the gun microphone wind shield 100, a first acoustic transmissive body 160, a microphone hold portion 140, and a gun microphone 300. FIG. 5 is an enlarged perspective view of a second end 116b of a cylindrical portion 114, the microphone hold portion 140, and the gun microphone 300. FIG. 6 is a cross-sectional view of the gun microphone wind shield 100 taken along a circumferential direction. FIG. 7 is a perspective view of a structure of the microphone hold portion 140. FIG. 8 is a perspective view of the microphone hold portion 140 to which the gun microphone 300 is attached. FIG. 9 is a cross-sectional view (FIG. 9A) of longitudinal flows of air and is a cross-sectional view (FIG. 9B) of circumferential flows of air in a first space SP10 and a second space SP20.

### Gun Microphone Wind Shield 100

The gun microphone wind shield 100 according to the first embodiment is a wind shield for use in the gun microphone 300. The gun microphone 300 has high directivity and can cancel out surrounding noise and pick up sounds ahead of the gun microphone 300.

### Gun Microphone (Shot-Gun Microphone) 300

As illustrated in FIG. 4, the gun microphone 300 has an almost columnar and elongated outer shape. The gun microphone 300 mainly has a microphone body 310 and an interference tube 320.

The interference tube 320 has an elongated, almost cylindrical shape. The interference tube 320 has a first end 330 and a second end 340 along the longitudinal direction. The first end 330 has an opening 332. Directing the opening 332 to a sound source as a sound-pickup target makes it possible to transfer sounds emitted from the sound source to the inside of the interference tube via the opening 332.

The interference tube 320 has the second end 340 connected to the microphone body 310 having a diaphragm. The diaphragm vibrates on receipt of the sounds propagated through the interference tube 320. The microphone body 310 converts the vibration of the diaphragm into an electric signal and outputs the same as an audio signal.

Further, the side surface of the interference tube 320 has a plurality of slits 350. The sounds emitted from a sound source positioned on the lateral side of the gun microphone 300 (the interference tube 320) pass through the plurality of slits 350 and enter the inside of the interference tube 320. The sounds having passed through the plurality of slits 350 interfere with and cancel out each other in the interference tube. The sounds emitted from a sound source on the lateral side of the gun microphone 300 are not sound-pickup targets. Causing the sounds having passed through the plurality of slits 350 to cancel out each other prevents the sounds from reaching the microphone body 310. In this way, the gun microphone 300 includes the interference tube 320 to pick up sounds with enhanced directivity.

The gun microphone 300 has a common tendency that, when being used outdoors, a flow of air such as wind is likely to contact not only the opening 332 but also the interference tube 320 in the gun microphone 300, that is, the gun microphone is susceptible to lateral wind. As described above, the interference tube 320 has the plurality of slits 350 in the side surface, and thus a flow of air such as wind is likely to enter the interference tube 320 via the plurality of slits 350. When the air flows into the interference tube 320, the diaphragm of the microphone body 310 is likely to vibrate and cause wind noise due to the flow of the air. Accordingly, the gun microphone wind shield 100 needs to cover the entire gun microphone 300 including the interference tube 320.

### Main Components of the Gun Microphone Wind Shield 100

As illustrated in FIGS. 2 to 4, the gun microphone wind shield 100 mainly has the outer enclosure 110, the vibration-proof hold portion 120, the first acoustic transmissive body 160, the microphone hold portion 140, and a terminal end lid body 170. As illustrated in FIG. 4, the outer enclosure 110, the first acoustic transmissive body 160, and the microphone hold portion 140 are all elongated and almost concentric (coaxial) to one another.

### Outer Enclosure 110

### Leading End Portion 112 and Cylindrical Portion 114

As illustrated in FIGS. 2 and 3, the outer enclosure 110 has a leading end portion 112 and a cylindrical portion 114. The leading end portion 112 has an almost hemispheric shape. The cylindrical portion 114 has an elongated cylindrical shape. The leading end portion 112 and the cylindrical portion 114 are formed from an elastic foaming body with open cells and have acoustic transmissivity to transmit external sounds as described later.

In addition, since being formed from an elastic foaming body, the outer enclosure 110 is elastically deformable in every portion. Accordingly, even when external shock or the like is applied, the outer enclosure 110 repeats elastic deformation and recovery to absorb the shock gradually. The outer enclosure 110 can constitute a vibration-proof structure. The vibration-proof structure of the outer enclosure 110 absorbs externally applied shock or the like to make the shock less likely to transfer to the gun microphone 300 and prevent the shock from being picked up as noise.

The radius of the cylindrical portion 114 is slightly longer than the radius of the first acoustic transmissive body 160. The longitudinal length of the cylindrical portion 114 is slightly larger than the longitudinal lengths of the first acoustic transmissive body 160 and the microphone hold portion 140.

### First End 116a and Second End 116b

The cylindrical portion 114 has a first end 116a and a second end 116b along the longitudinal direction. The leading end portion 112 is fixed to the first end 116a of the cylindrical portion 114 by adhesion or welding. The second end 116b has an almost circular opening.

### Cavity 118

As illustrated in FIGS. 5A and 5B, the cylindrical portion 114 has an elongated cavity 118 formed therein along the longitudinal direction. The first acoustic transmissive body 160 can be inserted into the cavity 118 from the opening in the second end 116b. Making the radius of the cavity 118 slightly smaller than the radius of the first acoustic transmissive body 160 allows the first acoustic transmissive body 160 to be inserted into the cavity 118 while the cylindrical portion 114 is slightly elastically deformed. The biasing force generated by the elastic deformation of the cylindrical portion 114 (the outer enclosure 110) makes it possible to hold the first acoustic transmissive body 160 in a constant position in the cavity 118. In this way, using the outer enclosure 110 formed from an elastic foaming body makes it possible to hold the first acoustic transmissive body 160 in a constant position in the outer enclosure 110 without using a member such as a fixing member.

Further, the first acoustic transmissive body 160 can store the microphone hold portion 140. Accordingly, the cylindrical portion 114 of the outer enclosure 110 can store the first acoustic transmissive body 160 and the microphone hold portion 140. In this way, the outer enclosure 110 can encompass entirely the first acoustic transmissive body 160 and the microphone hold portion 140.

### Material of the Outer Enclosure 110

The outer enclosure 110 is generally produced by foam-molding of a synthetic resin such as polyurethane, and is formed from a sponge-like elastic foaming body with open cells. For example, the outer enclosure 110 may contain fibers of polyester and cotton.

In the embodiment, the outer enclosure 110 is formed only from an elastic foaming body, and the outer shape of the outer enclosure 110 is defined by the shape of the elastic foaming body. Since the outer enclosure 110 is formed from an elastic foaming body, it is elastically deformable with elasticity.

### Relationship Between First Space SP10 and Second Space SP20

As illustrated in FIG. 6, the cylindrical portion 114 of the outer enclosure 110 has a predetermined thickness T1 as seen in the radius direction. The portion with the thickness T1 is formed only from an elastic foaming body. In addition, the cylindrical portion 114 has the elongated cavity 118 therein.

As illustrated in FIGS. 6, 9A, and 9B, the gun microphone wind shield 100 has a first space SP10 and a second space SP20 for dealing the air having entered the gun microphone wind shied 100. The gap between the first acoustic transmissive body 160 and the gun microphone 300 corresponds to the first space SP10, and the cylindrical portion 114 corresponds to the second space SP20 defined by the thickness T1. The functions of the first space SP10 and the second space SP20 will be described later.

### Vibration-Proof Hold Portion 120

### Vibration-Proof Hold Portion 120

As illustrated in FIGS. 2 and 3, the gun microphone wind shield 100 has a vibration-proof hold portion 120. The vibration-proof hold portion 120 has a hold body 122 and a grip portion 130.

### Hold Body 122

The hold body 122 includes a plurality of annular members 124. have an almost circular shape and the cylindrical portion 114 of the outer enclosure 110 are inserted into the annular members 124.

The cylindrical portion 114 (the outer enclosure 110) is formed from a sponge-like elastic foaming body with open cells and has porous properties. Accordingly, the surface of the cylindrical portion 114 is rough, and the annular members 124 can easily catch (stop) the surface of the cylindrical portion 114, whereby the annular members 124 can easily retain the cylindrical portion 114.

The cylindrical portion 114 has an elongated shape and does not come off the cylindrical portion 114 even when the annular members 124 slide over the cylindrical portion 114. For example, the annular members 124 are preferably provided in an intermediate position in the cylindrical portion 114.

The annular members 124 preferably can easily catch the surface of the cylindrical portion 114. For example, the roughness of portions of the annular members 124 to contact the surface of the cylindrical portion 114 is preferably decided as appropriate according to the material and roughness of the cylindrical portion 114. This allows the annular members 124 to catch easily the surface of the cylindrical portion 114 and prevents the cylindrical portion 114 from being broken when being caught.

The radius of the annular members 124 is slightly smaller than the radius of the cylindrical portion 114. Accordingly, when the annular members 124 are attached to the cylindrical portion 114, the cylindrical portion 114 is pressed and elastically deformed by the annular members 124. The annular members 124 are retained on the cylindrical portion 114 by biasing force generated by the elastic deformation of the cylindrical portion 114. Further, the annular members 124 may be provided with an additional adjustment mechanism of a bolt and a nut to adjust the effective diameter in the optimum engagement state.

It is preferred that the cylindrical portion 114 is not elastically deformed too much by the annular members 124. Ensuring the volume of the cylindrical portion 114 to maintain the second space SP20 makes it possible to attenuate a flow of air.

In this way, using not only the rough surface of the cylindrical portion 114 but also the biasing force generated by the elastic deformation of the cylindrical portion 114 makes it possible to retain the annular members 124 more firmly on the cylindrical portion 114.

The annular members 124 described above have a circular shape but may have any other shape. For example, the annular members may be formed in a belt-like (band-like) shape to circle around the cylindrical portion 114. Increasing the area of contact with the cylindrical portion 114 makes the annular members 124 easier to retain on the cylindrical portion 114.

Moreover, the annular members 124 may be provided with a portion protruding toward the cylindrical portion 114. For example, the annular members 124 may be provided with a claw-like projection toward the cylindrical portion 114. This further makes the annular members 124 easier to retain on the cylindrical portion 114.

In this way, increasing the area of contact with the cylindrical portion 114 and providing a projection or the like for facilitating engagement with the cylindrical portion 114 makes the annular members 124 easier to retain on the cylindrical portion 114.

Retaining the annular members 124 on the cylindrical portion 114 makes it possible to attach the hold body 122 to the outer enclosure 110 without having to process or deform the outer enclosure 110 or change the acoustic characteristics of the outer enclosure 110. In addition, the hold body 122 is detachably configured and thus is easy to carry and handle.

The vibration-proof hold portion 120 may be provided with a connector (not illustrated) for external connection of an internal cable (not illustrated) connected to the gun microphone 30. Connecting an external cable to the internal cable via the connector makes it possible to output electrical signals from the gun microphone 30 to the outside. This prevents shock and solid-borne sounds from transferring from the cable to the gun microphone 30. In addition, the gun microphone 30 can be carried with the internal cable connected, which increases the convenience in handling the gun microphone wind shield 100. Further, providing the internal cable with a blocking mass such as lead makes it possible to further reduce shock and solid-borne sounds in a reliable manner.

### Grip Portion 130

The grip portion 130 has a grip 132 and a coupling body 134. The grip 132 can be grasped by the user. The plurality of annular members 124 is coupled to the coupling body 134. The coupling body 134 holds the grip 132 rotatably.

The user can hold and support the grip portion 130 with his/her hand to direct the gun microphone 300 with the gun microphone wind shield 100 to a desired sound source. Even when the sound source is in a high position or low position, setting the appropriate angle formed by the coupling body 134 and the grip 132 allows the gun microphone 300 to be directed to the sound source.

The grip portion 130 is supported by the user's hand, and thus may be subjected to shock during use. The grip portion 130 is attached to the outer enclosure 110 via the annular members 124. As described above, the outer enclosure 110 constitutes a vibration-proof structure. Accordingly, even if the grip portion 130 is subjected to shock, the outer enclosure 110 absorbs the shock to prevent the shock from being picked up as noise (structure-borne sounds) by the gun microphone 300.

In this way, the grip portion 130 is a member for supporting indirectly the gun microphone 300 via the outer enclosure 110 to make shock or the like less likely to transfer directly to the gun microphone 300 by the vibration-proof structure of the outer enclosure 110.

### First Acoustic Transmissive Body 160

The first acoustic transmissive body 160 is formed by curving an almost thin sheet-like acoustic transmissive member into a cylindrical shape. The acoustic transmissive member blocks the passage of part of contacting air. The remaining unblocked air passes through the acoustic transmissive member. The acoustic transmissive member will be described later in detail.

### Shape and Size

As illustrated in FIG. 4, the first acoustic transmissive body 160 has an elongated and almost cylindrical shape. As described above, the radius of the first acoustic transmissive body 160 is slightly larger than the radius of the cavity 118 in the outer enclosure 110. This allows the cylindrical portion 114 to be slightly elastically deformed so that the first acoustic transmissive body 160 can be inserted in the cavity 118. The first acoustic transmissive body 160 is retained in the cylindrical portion 114 by biasing force generated by the elastic deformation of the cylindrical portion 114 (the outer enclosure 110).

The first acoustic transmissive body 160 has a sound source-side end portion 162 blocked with the acoustic transmissive member. Blocking the end portion 162 makes the air having flowed into via the leading end portion 112 of the outer enclosure 110 less likely to enter the first acoustic transmissive body 160. In addition, the first acoustic transmissive body 160 has an end 164 opposite to the sound source and opened so that the microphone hold portion 140 is inserted from the end 164 of the first acoustic transmissive body 160 to prevent intermittence or breakage in the wind-proof layer as described later.

### Arrangement

As illustrated in FIGS. 5A and 5B, forming the first acoustic transmissive body 160 in such a shape and size makes it possible to arrange the first acoustic transmissive body 160 in an almost concentric (coaxial) manner to be covered by the outer enclosure 110.

The microphone hold portion 140 is arranged inside the first acoustic transmissive body 160 along the longitudinal direction. The radius of the first acoustic transmissive body 160 is set to be slightly larger than the radius of the microphone hold portion 140.

As illustrated in FIGS. 5A and 5B, the gun microphone 300 is stored in the microphone hold portion 140. The first acoustic transmissive body 160 has a cylindrical shape, and the longitudinal length of the first acoustic transmissive body 160 is longer than the longitudinal length of the gun microphone 300. Accordingly, the gun microphone 300 can be smoothly attached to or detached from the first acoustic transmissive body 160 via the microphone hold portion 140, and the entire gun microphone 300 can be stored in the first acoustic transmissive body 160.

### Acoustic Transmissive Member

The acoustic transmissive member is formed from a fiber material obtained by intertwining a raw material containing fibers, and the air permeability of the fiber material is less than 0.5 s/100 ml. This is because the fiber material used as the acoustic transmissive material is obtained by interlacing a raw material with an air permeability of 0.5 s/100 ml and thus provides a fiber density enough to have an uncountable number of irregular air gaps to shut off wind of a cause of whistling sounds.

That is, the acoustic transmissive member made from such a fiber material acts as a shield or a movement direction converter (flap) for “wind” of movement of an air molecule mass, and is almost completely permeable to “sound” of movement of pressure change (the medium itself does not move but only vibrate).

When the fiber material has enough freestanding properties (stiffness), the acoustic transmissive member does not need to be combined with any other member. However, the acoustic transmissive member may be configured so that the fiber material is sandwiched between two net-like bodies, for example.

The acoustic transmissive member will be described below in detail.

As described above, the acoustic transmissive member transmits a predetermined frequency range (20 to 20 kHz) and the constituent fiber material has an air permeability of less than 0.5 s/100 ml. With the foregoing properties, the acoustic transmissive member is significantly improved in acoustic transmissivity. The air permeability means the time taken for a certain amount of air to pass through a certain area under a certain pressure. In particular, it means the time taken for an air of 100 ml to pass through a sheet-like acoustic transmissive material. The air permeability is measured by Gurley method stipulated in JIS P8117.

The air permeability of less than 0.5 s/100 ml means that it falls under a measurable range of 0.5 s/100 ml or more of the measurement device used in the present application.

The acoustic transmissive member is obtained by interlacing a raw material containing fibers. For example, a fiber material with interlaced fibers can be formed by a wet forming method. The raw material used for manufacture of the fiber material is metallic fibers or fluorine fibers in the first embodiment. The fiber material used as the acoustic transmissive member has a thickness of 3 mm or less, preferably 10 μm to 2000 μm, more preferably 20 μm to 1500 μm. Setting such a thickness makes it possible to obtain the effect of reducing whistling sounds by a minimum and simple structural frame with a certain degree of stiffness.

However, the raw material for the fiber material is not limited to a metallic fiber or a fluorine fiber, and the thickness of the fiber material is not limited to the foregoing values.

Next, the material for metallic fibers as a raw material for the fiber material will be described.

To manufacture the acoustic transmissive member from metallic fibers using a wet forming method, the metallic fiber material is obtained by processing slurry containing one or two or more kinds of metallic fibers using a wet forming method. To manufacture the acoustic transmissive member from metallic fibers using compression molding, the metallic fiber material is obtained using heating and pressurizing an aggregate of metallic fibers. In either case, the resultant metallic fiber material has interlaced metallic fibers. There is no particular limitation on the shape of the metallic fiber material but the metallic fiber material is preferably a metallic fiber sheet.

The material, structure, and manufacturing method of the metallic fibers will be described below in detail. The descriptions in JP 2000-80591 A, Japanese Patent No. 2649768, and Japanese Patent No. 2562761, which provide the metallic fiber material and the method for manufacturing the same, are incorporated by reference in its entirety.

One or two or more kinds of metallic fibers as the material for metallic fibers are a combination of one or two or more kinds selected from fibers made from stainless steel, aluminum, brass, copper, titanium, nickel, gold, platinum, lead, and the like.

The metallic fiber material has a structure that metallic fibers are interlaced.

The metallic fibers constituting the metallic fiber has a fiber diameter of 1 to 50 μm, preferably 2 to 30 μm, more preferably 8 to 20 μm. Such metallic fibers are suited for interlacing, and interlacing such metallic fibers makes it possible to form a low-lint metallic fiber sheet with acoustic transmissivity.

The manufacture of the metallic fiber material by a wet forming method includes a fiber interlacing process in which the metallic fibers as a net-like wet sheet are interlaced while slurry containing one or two or more kinds of metallic fibers is shaped into a sheet form using a wet forming method.

In the fiber interlacing process, preferably, high-pressure jets of water are sprayed onto the metallic fiber sheet after papermaking, for example. Specifically, a plurality of nozzles is arranged in a direction orthogonal to the flowing direction of the sheet to spray high-pressure jets of water at the same time to interlace the metallic fibers in the entire sheet. That is, when high-pressure jets of water are sprayed onto the sheet of metallic fibers crossed one another irregularly in a plane direction by wet forming, in a Z-axis direction of the sheet, for example, the metallic fibers onto which the high-pressure jets of water have been sprayed are oriented in the Z-axis direction. The metallic fibers oriented in the Z-axis direction gets tangled with the metallic fibers oriented irregularly in the plane direction. These fibers are tangled with one another three-dimensionally, that is, are interlaced to obtain physical strength.

In addition, the sheet forming method may be selected as necessary from various methods such as Fourdrinier forming, cylinder forming, and inclined wire forming. At manufacture of slurry containing long metallic fibers, dispersiveness of the metallic fibers in the water may be insufficient. Accordingly, a small amount of polymer aqueous solution with thickening properties may be added to the slurry. The polymer includes polyvinyl pyrrolidone, polyvinyl alcohol, or carboxymethyl cellulose (CMC).

According to the method for manufacturing the metallic fiber material by compression molding, first, the fibers are brought together and compressed preliminarily to form a web, or the fibers are impregnated with a binder to bind the fibers and then compressed preliminarily. After that, the aggregate of metallic fibers is heated and pressurized to form a metallic fiber sheet. There is no particular limitation on the binder. For example, organic binders such as an acrylic adhesive, an epoxy adhesive, and a urethane adhesive, and inorganic adhesives such as colloidal silica, water glass, and sodium silicate can be used. Instead of impregnating the fibers with a binder, the surface of the metallic fibers may be coated in advance with a thermobonding resin, and an aggregate of the metallic fibers is layered and then heated and bonded. The amount of impregnation with a binder is preferably 5 to 130 g, more preferably 20 to 70 g for a sheet plane weight of 1000 g/m2.

The aggregate of metallic fibers is heated and pressurized to form the sheet. The heating conditions are set in consideration to the binder used, and the drying temperature and curing temperature of the thermobonding resin. The heating temperature is generally about 50 to 1000° C. The applied pressure is adjusted in consideration to the elasticity of the fibers, the thickness of the acoustic transmissive member, and the light transmissivity of the acoustic transmissive member. To impregnate the acoustic transmissive member with a binder by spraying, the metallic fiber layer is preferably molded to a predetermined thickness by pressing or the like prior to the spraying.

In addition, the method for manufacturing the metallic fiber material preferably includes a sintering process in which, after the wet forming process described above, the obtained metallic fiber material is sintered at a temperature equal to or lower than the melting point of the metallic fibers in vacuum or in a non-oxidizing atmosphere (in the case of compression molding, a heating and pressurization process substitutes for the sintering process). That is, after the wet forming process, the sintering process is performed to interlace the fibers, which eliminates the need to add an organic binder or the like to the metallic fiber material. This makes it possible to manufacture the metallic fiber material with a metal-specific glossy surface without trouble in the sintering process that might be caused by a cracked gas from an organic binder or the like. In addition, the metallic fibers are interlaced to further improve the strength of the sintered metallic fiber material. Further, the sintered metallic fiber material is high in acoustic transmissivity and water-proof property. If not being sintered, the remaining thickening polymers in the metallic fiber material might absorb water to deteriorate water-proof property.

Next, the material for fluorine fibers as a raw material for the fiber material will be described.

In the case of using the fluorine fibers, the fluorine fiber material becomes a material (paper) in which short fluorine fibers are oriented in irregular directions and are bonded by thermal fusion.

The material and method for manufacturing the fluorine fibers will be described below in detail. As the material and method for manufacturing the fluorine fiber material, the descriptions in JP 63-165598 A are incorporated by reference in its entirety.

The fluorine fibers are produced from a thermoplastic fluorine resin mainly containing polytetrafluoroethylene (PTFE), tetrafluoroethylene (TFE), perfluoroether (PFE), copolymer of tetrafluoroethylene and hexafluoropropylene (FEP), copolymer of tetrafluoroethylene and ethylene or propylene (ETFE), polyvinylidene fluoride (PVDF), polychlorotrifluoroethylene (PCTFE), or polyvinyl fluoride (PVF). However, the main ingredients are not limited to them but may be mixed with the foregoing or other ones. The fluorine fibers are preferably single fibers with a fiber length of 1 to 20 mm so that they can be shaped into sheet form by a wet forming method. In addition, the fluorine fibers preferably have a fiber diameter of 2 to 30 μm.

The fluorine fiber material can be produced by mixing and drying the fluorine fibers and a self-adhesiveness substance by a wet forming method into a fluorine fiber-mixed sheet material, subjecting the sheet material to thermal compression bonding at the softening point of the fluorine fibers or more to fuse thermally the fluorine fibers, removing the self-adhesiveness substance by solving in a solvent, and re-drying the material as necessary.

The self-adhesiveness substance may be natural pulp made from plant fibers such as wood, cotton, hemp, and straw generally used for paper making, synthetic pulp or synthetic fibers made from polyvinyl alcohol (PVA), polyester, aromatic polyamide, acryl or polyolefin thermoplastic synthetic copolymers, or a paper strength additive made from natural copolymers or synthetic copolymers. However, the self-adhesiveness substance is not limited to them as far as it has self-adhesiveness and can be dispersed in water together with fluorine fibers.

The acoustic transmissive member of the present invention is not limited to the foregoing ones as far as the acoustic transmissive member includes a fiber material obtained by shaping a raw material containing fibers into sheet form by a wet forming method and the fiber material has an air permeability of less than 0.5 s/100 ml.

As described above, the acoustic transmissive member has a fiber density enough to have an uncountable irregular air gaps and can shut off wind as a cause of whistling sounds. The acoustic transmissive member formed from a fiber material acts as a shield or a movement direction converter (flap) for “wind” as movement of an air molecule mass, and is almost completely permeable to “sound” as movement of pressure change (the medium itself does not move but only vibrate).

The first acoustic transmissive body 160 is formed from the foregoing acoustic transmissive member and can basically shut off wind as a cause of whistling sounds.

However, the gun microphone 300 is used outdoor in many cases and is susceptible to lateral wind in particular. In addition, the gun microphone 300 inevitably has a large area to contact the air due to its elongated shape. Accordingly, it is necessary to provide the outer enclosure 110 covering the first acoustic transmissive body 160 to form the second space SP20 described later and shut off a flow of air in a reliable manner.

### Microphone Hold Portion 140

The microphone hold portion 140 is a member to hold the gun microphone 300. As illustrated in FIGS. 4, 7, and 8, the microphone hold portion 140 has an elongated shape and is stored in the first acoustic transmissive body 160.

The microphone hold portion 140 has two straight metallic frames 142, a circular leading end metallic frame 144, three circular circling metallic frames 146, and a terminal end metallic frame 148. The leading end metallic frame 144 is attached to a leading end 152 of the microphone hold portion 140. The terminal end metallic frame 148 is attached to a terminal end 154 of the microphone hold portion 140. The straight metallic frames 142, the leading end metallic frame 144, the circling metallic frame 146, and the terminal end metallic frame 148 can hold their respective constant shapes and can be formed from a metal or a resin. However, they are desirably made as small as possible by setting the frame material diameter to about 2 mm or less while keeping stiffness such that the quality (frequency spectrum) of the sound to be picked up is not influenced, that is, the insertion loss is sufficiently small or almost zero in all the frequency bands.

The leading end 152 of the microphone hold portion 140 is an end on the side where the first end 330 (opening 332) of the gun microphone 300 is positioned, and the terminal end 154 is an end on the side where the second end 340 of the gun microphone 300 is positioned.

The two straight metallic frames 142 are arranged in parallel to each other and are oriented in the longitudinal direction of the microphone hold portion 140. The two straight metallic frames 142 are formed in such a manner as to gradually come closer to each other toward the leading end 152, and are coupled together at the leading end 152. Accordingly, the diameter of the microphone hold portion 140 can be gradually thinner with increasing proximity to the leading end 152. This prevents the gun microphone 300 from coming off the microphone hold portion 140, and allows the gun microphone 300 to be held in a stable manner.

In addition, at the leading end 152 of the microphone hold portion 140, the two straight metallic frames 142 are coupled by the leading end metallic frame 144. Coupling the two straight metallic frames 142 by the leading end metallic frame 144 makes it possible to keep the shape of the leading end 152 of the microphone hold portion 140.

As illustrated in FIG. 8, the opening 332 in the interference tube 320 of the gun microphone 300 is positioned in the leading end metallic frame 144. The leading end metallic frame 144 makes it possible to arrange the gun microphone 300 without blocking the front side of the opening 332 and pick up properly the sounds emitted from the sound source.

The two straight metallic frames 142 are coupled together by the circling metallic frame 146 at different three positions along the longitudinal direction. This makes it possible to prevent the two straight metallic frames 142 from coming closer to each other or separating from each other, thereby to keep constantly the diameter of the microphone hold portion 140.

The terminal end metallic frame 148 is coupled to the terminal end 154 of the microphone hold portion 140. The terminal end metallic frame 148 includes an outer circular metallic frame, an inner circular metallic frame, and a square metallic frame.

The outer circular metallic frame and the inner circular metallic frame are concentric to each other, and the outer circular metallic frame is coupled to the terminal end 154 of the two straight metallic frames 142. The square metallic frame couples together the outer circular metallic frame and the inner circular metallic frame. Forming the terminal end 154 of the microphone hold portion 140 from these metallic frames makes it possible to disperse the force applied to the gun microphone 300 at the time of attachment and detachment, thereby keeping constantly the shape of the terminal end 154 of the microphone hold portion 140.

The diameter of the inner circular metallic frame is slightly larger than the diameter of the gun microphone 300. This makes it possible to smoothly pass the gun microphone 300 through the inner circular metallic frame.

Forming the microphone hold portion 140 from the metallic frames makes it possible to hold the gun microphone 300 on the microphone hold portion 140 without blocking the slits 350 in the side surface of the interference tube 320. Forming the microphone hold portion 140 from the metallic frames makes it possible to reduce the weight of the microphone hold portion 140 and facilitate the handling of the gun microphone wind shield 100. Forming the microphone hold portion 140 from the metallic frames makes it possible to keep the stiffness of the microphone hold portion 140 and hold the gun microphone 300 in a stable manner.

### Hold Member 158

Each of the three circling metallic frames 146 has four hold members 158. The four hold members 158 face one another, that is, circle around the hold member 158 at about 90 degrees each. The hold members 158 are formed from an elastic member such as rubber. For example, the elastic member may be formed from a gel-like flexible material made from silicone or the like, for example. The hold members 158 can be used for shock absorption or vibration prevention for their elastic deformation.

When the gun microphone 300 is stored in the microphone hold portion 140, the gun microphone 300 is held by the four each hold members 158 of the three circling metallic frames 146. The hold members 158 absorb shock and prevent the shock from being picked up as noise.

### Guide Auxiliary Member 150

A guide auxiliary member 150 is an auxiliary member to hold the gun microphone 300. The guide auxiliary member 150 is formed from four resin guide members 156. The four guide members 156 face one another and are arranged in parallel to the two straight metallic frames 142.

The straight metallic frames 142, the leading end metallic frame 144, the circling metallic frames 146, and the terminal end metallic frame 148 have their respective constant shapes. However, the guide members 156 may have a constant shape or may be flexible and deformable. The guide auxiliary member 150 is a member that, when the gun microphone 300 is attached to or detached from the microphone hold portion 140, guides the gun microphone 300 so as not to extend off or come off the microphone hold portion 140. Providing the guide auxiliary member 150 makes it possible to guide smoothly the gun microphone 300 along the inside of the microphone hold portion 140.

The two straight metallic frames 142 and the four guide members 156 are arranged along the longitudinal direction of the surface of a virtual elongated cylinder. The virtual elongated cylinder defines the outer shape of the inside of the microphone hold portion 140.

As illustrated in FIGS. 4, 5A, and 5B, the gun microphone 300 is stored in the microphone hold portion 140, and the microphone hold portion 140 is stored in the first acoustic transmissive body 160. The first acoustic transmissive body 160 is stored in the cavity 118 of the outer enclosure 110. In this way, the gun microphone 300, the microphone hold portion 140, and the first acoustic transmissive body 160 are stored in the outer enclosure 110.

The microphone hold portion 140 is stored in the first acoustic transmissive body 160. The microphone hold portion 140 makes it possible to hold the shape of the first acoustic transmissive body 160 from the inside of the first acoustic transmissive body 160. The first acoustic transmissive body 160 is stored in the outer enclosure 110. The outer enclosure 110 makes it possible to hold the position of the first acoustic transmissive body 160.

As described above, the gun microphone 300 is stored in the microphone hold portion 140, and the microphone hold portion 140 is stored in the first acoustic transmissive body 160. The gun microphone 300 is held on the microphone hold portion 140 by the hold members 158. The hold members 158 have a predetermined thickness. The thickness of the hold members 158 makes it possible to hold the gun microphone 300 in a position separated from the two straight metallic frames 142. In this way, in the inside of the first acoustic transmissive body 160, there is formed a gap between the first acoustic transmissive body 160 and the gun microphone 300 to define the first space SP10.

### Terminal End Lid Body 170

As illustrated in FIGS. 2 to 4, the gun microphone wind shield 100 has a terminal end lid body 170. The terminal end lid body 170 is formed from the same material as that of the outer enclosure 110, blocks the terminal end side of the gun microphone wind shield 100 to prevent intermittence in the wind shield layer. In addition, the terminal end lid body 170 acts as a stopper that fixes the gun microphone 300 in a predetermined position. The terminal end lid body 170 is the same in shape as the leading end portion 112. The terminal end lid body 170 is formed from an elastic foaming body with open cells and has acoustic transmissivity to transmit external sounds.

The terminal end lid body 170 is attached to the second end 116b of the cylindrical portion 114. Attaching the terminal end lid body 170 to the second end 116b of the cylindrical portion 114 makes it possible to cover entirely the gun microphone 300, the microphone hold portion 140, and the first acoustic transmissive body 160 by the elastic foaming body with open cells, thereby constituting the gun microphone wind shield 100.

### First Space SP10

As illustrated in FIGS. 6, 9A, and 9B, in the inside of the first acoustic transmissive body 160, there is formed a gap between the first acoustic transmissive body 160 and the gun microphone 300 to define the first space SP10. The first space SP10 is an almost cylindrical gap as a whole. The longitudinal length of the first space SP10 is determined by the longitudinal length of the first acoustic transmissive body 160. The thickness of side surface of the first space SP10 constitutes a distance D1 between the first acoustic transmissive body 160 and the gun microphone 300 (hereinafter, called diametrical thickness D1 of the first space SP10 (see FIG. 6)).

### Second Space SP20

As described above, the cylindrical portion 114 of the outer enclosure 110 has the thickness T1 in the radial direction (see FIG. 6), and the thickness T1 defines the second space SP20. The second space SP20 is an almost cylindrical gap as a whole. The longitudinal length of the second space SP20 is determined by the longitudinal length of the cylindrical portion 114. The thickness of side surface of the second space SP20 constitutes the thickness T1 in the radial direction of the cylindrical portion 114 (hereinafter, called diametrical thickness T1 of the second space SP20).

### Flows of Air in the Second Space SP20 (Change in Pressure)

FIG. 9A is a cross-sectional view of flows of air guided along the longitudinal direction in the second space SP20. FIG. 9B is a cross-sectional view of flows of air guided along the circumferential direction (the direction that circles around the first acoustic transmissive body 160) in the second space SP20.

The second space SP20 is a region that is defined by the cylindrical portion 114 of the outer enclosure 110 and is occupied by an elastic foaming body.

The air having passed through the surface of the outer enclosure 110 then enters the second space SP20. The air having entered the second space SP20 then enters the elastic foaming body. The elastic foaming body has open cells and the air having entered the elastic foaming body moves along the open cells. The elastic foaming body can control the flowing direction of the air. In addition, the flow of the air can be interfered and slowed down gradually by collision with the open cells. In this way, the elastic foaming body can suppress the velocity of the air.

Further, the air having entered the second space SP20 travels while being interfered with by contact with the first acoustic transmissive body 160. In this way, the air having entered the elastic foaming body moves in the second space SP20 and gradually slows down while being guided by the first acoustic transmissive body 160.

The air moving in the second space SP20 has a component LP20 that moves along the longitudinal direction of the first acoustic transmissive body 160 (see FIG. 9A), and a component AP20 that moves along the circumferential direction of the first acoustic transmissive body 160 (see FIG. 9B).

### Longitudinal Flows of Air in the Second Space SP20

The second space SP20 is a space that exists (extends) in the longitudinal direction according to the longitudinal length of the gun microphone 300. The longitudinal length of the second space SP20 can be decided depending on the outer shape (length) of the used gun microphone 300. For example, the longitudinal length of the second space SP20 can be obtained by adding a length equal to or longer than the diameter of the gun microphone 300 to the longitudinal length of the gun microphone 300. The longitudinal length of the second space SP20 can be ten times or more the diameter of the gun microphone 300, but is preferably two to five times the diameter of the gun microphone 300.

The second space SP20 is a region that allows the air to flow in the longitudinal direction, and the air having entered the second space SP20 can move in the longitudinal direction. Providing the second space SP20 as the space where the air can move sufficiently in the longitudinal direction increases the opportunities to move and slow down the air gradually, thereby making the air less likely to enter the first space SP10 from the second space SP20.

In this way, the second space SP20 provides a region where the air can flow in the longitudinal direction, and acts as an air flow buffer area to make the air less likely to enter the first space SP10.

### Circumferential Flows of Air in the Second Space SP20

The diametrical thickness T1 of the second space SP20 can be decided according to the diameter of the gun microphone 300. For example, the diametrical thickness T1 of the second space SP20 can be equal to or smaller than the diameter of the gun microphone 300 or equal to or smaller than the radius of the gun microphone 300. The diametrical thickness T1 of the second space SP20 may be larger than the diameter of the gun microphone 300. As a whole, the second space SP20 is preferably configured so that the leading end has an almost hemisphere shape or streamline shape.

The second space SP20 only needs to act as an air flow buffer area and provide a space for attenuating the movement of the air. Basically, the second space SP20 is preferably configured to provide an almost uniform air layer over the entire perimeter of the gun microphone 300.

The second space SP20 is a region for flowing the air in the circumferential direction, and the air having entered the second space SP20 can move along the circumferential direction. Providing the second space SP20 as the space where the movement of the air can be attenuated in the circumferential direction increases the opportunities to move and slow down the air gradually, thereby making the air less likely to enter the first space SP10 from the second space SP20.

In this way, the second space SP20 provides a region where the air can be attenuated while flowing in the longitudinal and circumferential directions, and acts as an air flow buffer area to make the air less likely to enter the first space SP10.

### Flows of Air in the First Space SP10 (Change in Pressure

FIG. 9A is a cross-sectional view of flows of air guided along the longitudinal direction in the first space SP10. FIG. 9B is a cross-sectional view of flows of air guided along the circumferential direction (the direction that circles around the gun microphone 300) in the first space SP10.

The first space SP10 is a region sandwiched between the first acoustic transmissive body 160 and the gun microphone 300. The first space SP10 is not charged with an elastic foaming body, unlike the second space SP20. Depending on the use environment of the gun microphone 300, the first space SP10 may be charged with an elastic foaming body as appropriate.

As described above, the second space SP20 (elastic foaming body) acts as a buffering region for gradually slowing down the air having entered the second space SP20. Therefore, the air is less likely to pass through the first acoustic transmissive body 160. However, depending on the use environment of the gun microphone 300, the air may pass through the first acoustic transmissive body 160. When having passed through the first acoustic transmissive body 160, the air also enters the first space SP10.

The air having entered the first space SP10 travels while being interfered with by each contact with the first acoustic transmissive body 160 and the gun microphone 300. In this way, the air having entered the first space SP10 moves in the first space SP10 while being attenuated by each contact with the first acoustic transmissive body 160 and the gun microphone 300.

As in the second space SP20, the air moving in the first space SP10 has a component LP10 moving along the longitudinal direction of the first acoustic transmissive body 160 and the gun microphone 300 (see FIG. 9A) and a component AP10 moving along the circumferential direction of the first acoustic transmissive body 160 and the gun microphone 300 (see FIG. 9B).

### Longitudinal Flows of Air in the First Space SP10

The first space SP10 is a space that exists (extends) in the longitudinal direction according to the longitudinal length of the gun microphone 300. The longitudinal length of the first space SP10 can be decided depending on the outer shape of the used gun microphone 300. For example, the longitudinal length of the first space SP10 may be almost identical to or slightly larger than the longitudinal length of the gun microphone 300, and can be obtained by adding a length about two to five times the diameter of the gun microphone 300.

The first space SP10 is a region that allows the air to flow in the longitudinal direction, and the air having entered the first space SP10 can move in the longitudinal direction. Specifically, the air having entered the first space SP10 can be guided in the longitudinal direction by the first acoustic transmissive body 160 and gradually slowed down by contact with the first acoustic transmissive body 160. Providing the first space SP10 as the space where the air can move sufficiently in the longitudinal direction increases the opportunities to move and slow down the air gradually, which makes the air less likely to leak from the first space SP10 toward the gun microphone 300.

In this way, the first space SP10 provides a region where the air can flow in the longitudinal direction, and acts as an air flow buffer area to make the air less likely to enter the gun microphone 300.

### Circumferential Flows of Air in the First Space SP10

The diametrical thickness D1 of the first space SP10 can be decided according to the diameter of the gun microphone 300, but is preferably decided in consideration to the basic function of a wind shield for reducing wind noise and the ease of handling the gun microphone 300. Basically, it is possible to reduce wind noise in lower sound range with increase in D1. For example, the diametrical thickness D1 of the first space SP10 can be equal to or smaller than the diameter of the gun microphone 300 or equal to or smaller than the radius of the gun microphone 300. The diametrical thickness D1 of the first space SP10 may be larger than the diameter of the gun microphone 300.

The first space SP10 only needs to act as an air flow buffer area and provide a space where the air can move sufficiently. The space where the air can move sufficiently can be decided by a balance between the longitudinal length of the first space SP10 and the diametrical thickness D1 of the first space SP10. For example, even when the diametrical thickness D1 of the first space SP10 is shortened, increasing the longitudinal length of the first space SP10 can provide a space where the air can move sufficiently.

The first space SP10 is a region for flowing the air in the circumferential direction, and the air having entered the first space SP10 can move along the circumferential direction. Providing the space where the air can move sufficiently in the circumferential direction as the first space SP10 increases the opportunities to move and slow down the air gradually, which makes the air less likely to leak from the first space SP10 toward the gun microphone 300.

In this way, the first space SP10 provides a region where the air can flow in the circumferential direction, and acts as an air flow buffer area to make the air less likely to enter the gun microphone 300.

### Suppression of Negative Pressure Fluctuation in the First Space SP10 and the Second Space SP20

As described above, the air flows into the microphone body 310 of the gun microphone 300 to vibrate the diaphragm and generate wind noise. Further, wind noise is generated not only by the direct inflow of air but also by fluctuation in the surrounding pressure.

The gun microphone wind shield 100 has the first space SP10 and the second space SP20 to move the air sufficiently in the longitudinal direction and slow down the moving air, thereby absorbing negative pressure fluctuation. In this way, causing the first space SP10 and the second space SP20 to act as two-step buffer areas to suppress negative pressure fluctuation in a stepwise manner.

Accordingly, the gun microphone wind shield 100 has the first space SP10 and the second space SP20 as described above to make the air less likely to enter the gun microphone 300 and to prevent wind noise generated from the diaphragm vibrated by the air.

Further, even in the case where the air does not enter the gun microphone 300, the air may flow around the gun microphone 300 to generate negative pressure fluctuation that vibrates the diaphragm. In such a case, the formation of the first space SP10 and the second space SP20 makes it possible to suppress negative pressure fluctuation and prevent the occurrence of wind noise due to the negative pressure fluctuation.

In this way, the first space SP10 and the second space SP20 can not only shut off the movement of the air but also suppress the occurrence of negative pressure fluctuation.

### SECOND EMBODIMENT

In the foregoing first embodiment, the microphone hold portion 140 holds the gun microphone 300 inside the first acoustic transmissive body 160. In the second embodiment, a second acoustic transmissive body 260 is used instead of the microphone hold portion 140. In the second embodiment, the same components as those of the first embodiment are given the same reference signs as those of the first embodiment.

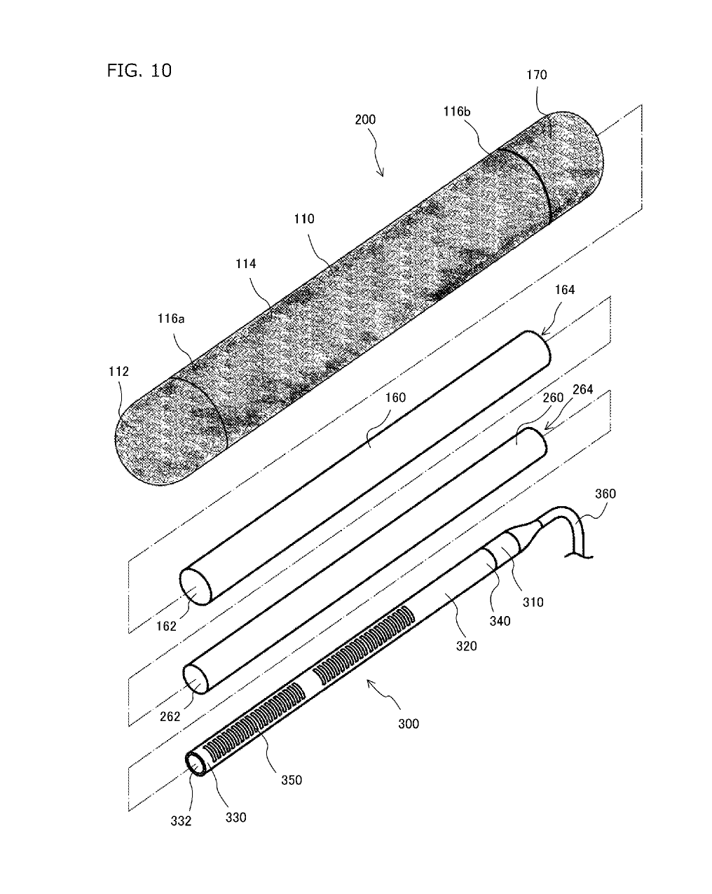

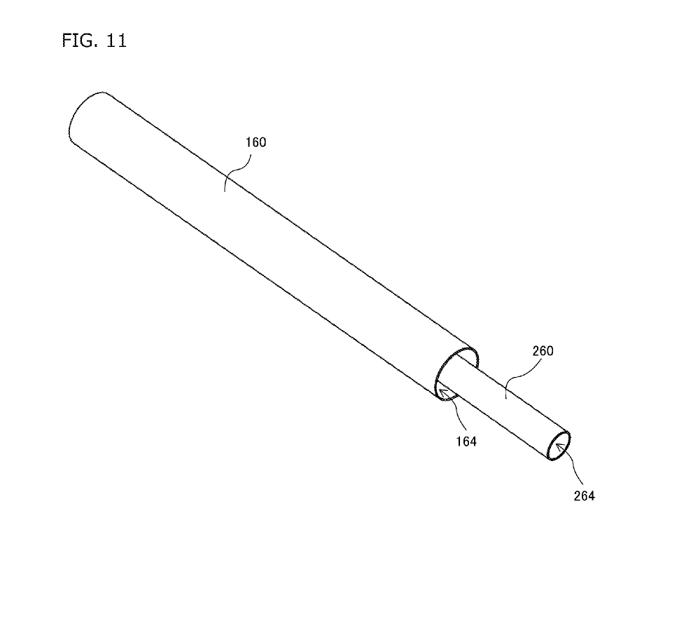

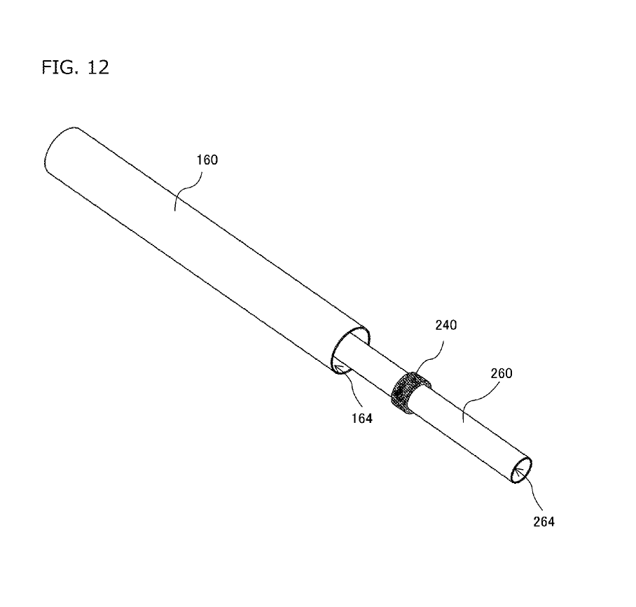

FIG. 10 is a perspective view of a configuration of a gun microphone wind shield 200 according to the second embodiment. FIG. 11 is a perspective view of the first acoustic transmissive body 160 and the second acoustic transmissive body 260 according to the second embodiment. FIG. 12 is a perspective view of an elastic hold body 240 provided between the first acoustic transmissive body 160 and the second acoustic transmissive body 260 according to the second embodiment.

As illustrated in FIG. 10, the gun microphone wind shield 200 in the second embodiment includes mainly an outer enclosure 110, the first acoustic transmissive body 160, and the second acoustic transmissive body 260.

### Outer Enclosure 110

The outer enclosure 110 has the same configuration and function as those of the gun microphone wind shield 100 in the first embodiment. The outer enclosure 110 has a leading end portion 112 and a cylindrical portion 114. The leading end portion 112 and the cylindrical portion 114 are formed from an elastic foaming body with open cells and have acoustic transmissivity to transmit external sounds.

The outer enclosure 110 is formed from an elastic foaming body and thus is elastically deformable in every portion. Accordingly, even when external shock or the like is applied, the outer enclosure 110 repeats elastic deformation and recovery to absorb the shock gradually. The outer enclosure 110 can constitute a vibration-proof structure. The vibration-proof structure of the outer enclosure 110 absorbs externally applied shock or the like to make the shock less likely to transfer to the gun microphone 300 and prevent the shock from being picked up as noise.

The cylindrical portion 114 has an elongated cavity 118 formed therein along the longitudinal direction. The first acoustic transmissive body 160 can be inserted into the cavity 118. The biasing force generated by the elastic deformation of the cylindrical portion 114 makes it possible to hold the first acoustic transmissive body 160 in a constant position in the cavity 118. The first acoustic transmissive body 160 can be held in a constant position in the outer enclosure 110 without having to use a member such as a fixing member.

### Attachment of Vibration-Proof Hold Portion 120 (Hold Body 122 and Grip Portion 130)

In the gun microphone wind shield 200 according to the second embodiment as well, the outer enclosure 110 is arranged on the outermost periphery, and the hold body 122 and the grip portion 130 can be detachably attached to the outer enclosure 110 as in the first embodiment. The mode of attaching the hold body 122 to the outer enclosure 110 is the same as that in the gun microphone wind shield 100 in the first embodiment (see FIGS. 1 and 2 and the descriptions thereof).

In this way, the hold body 122 can also be attached to the outer enclosure 110 of the gun microphone wind shield 200 in the second embodiment to retain the annular members 124 on the cylindrical portion 114. This makes it possible to attach the hold body 122 to the outer enclosure 110 without having to process or deform the outer enclosure 110 or change the acoustic characteristics of the outer enclosure 110. In addition, the hold body 122 is detachably configured and thus is easy to carry and handle.

The grip portion 130 is supported by the user's hand, and thus may be subjected to shock during use. The grip portion 130 is attached to the outer enclosure 110 by the annular members 124. As in the first embodiment, the outer enclosure 110 constitutes a vibration-proof structure. Accordingly, even if the grip portion 130 is subjected to shock, the outer enclosure 110 absorbs the shock to prevent the shock from being picked up as noise by the gun microphone 300.

In this way, the grip portion 130 is a member for supporting indirectly the gun microphone 300 via the outer enclosure 110 to make shock or the like less likely to transfer directly to the gun microphone 300.

### First Acoustic Transmissive Body 160

The first acoustic transmissive body 160 has the same configuration and function as those of the gun microphone wind shield 100 in the first embodiment. The first acoustic transmissive body 160 is formed by curving an almost thin sheet-like acoustic transmissive member into a cylindrical shape. The acoustic transmissive member blocks the passage of part of contacting air. The remaining unblocked air passes through the acoustic transmissive member.

The first acoustic transmissive body 160 has an elongated and almost cylindrical shape. The first acoustic transmissive body 160 can be inserted into the cavity 118 while the cylindrical portion 114 of the outer enclosure 110 is slightly elastically deformed. The first acoustic transmissive body 160 is retained on the cylindrical portion 114 by the biasing force generated by the elastic deformation of the cylindrical portion 114.

The first acoustic transmissive body 160 has a sound source-side end portion 162 blocked with the acoustic transmissive member. This makes the air having flowed into the outer enclosure 110 via the leading end portion 112 less likely to enter the first acoustic transmissive body 160.

### Second Acoustic Transmissive Body 260

The second acoustic transmissive body 260 is formed by curving an almost thin sheet-like acoustic transmissive member into a cylindrical shape like the first acoustic transmissive body 160. The acoustic transmissive member blocks the passage of part of contacting air. The remaining unblocked air passes through the acoustic transmissive member.

As illustrated in FIGS. 10, 11, and 12, the second acoustic transmissive body 260 has an elongated and almost cylindrical shape. As described above, the radius of the second acoustic transmissive body 260 is configured to be smaller than the radius of the first acoustic transmissive body 160. This forms a third space SP30 between the first acoustic transmissive body 160 and the second acoustic transmissive body 260.

The second acoustic transmissive body 260 has a sound source-side end portion 262 blocked with the acoustic transmissive member. This makes air less likely to enter the second acoustic transmissive body 260.

As illustrated in FIGS. 10 to 13, forming the second acoustic transmissive body 260 in such a shape and size makes it possible to arrange the second acoustic transmissive body 260 in an almost concentric (coaxial) manner so that the second acoustic transmissive body 260 is covered with the first acoustic transmissive body 160.

As described later, the gun microphone 300 is positioned along the longitudinal direction inside the second acoustic transmissive body 260. The radius of the second acoustic transmissive body 260 is set to be slightly larger than the radius of the gun microphone 300.

### Elastic Hold Body 240

The elastic hold body 240 is arranged between the first acoustic transmissive body 160 and the second acoustic transmissive body 260. The elastic hold body 240 has an annular shape. The elastic hold body 240 is formed from an elastically deformable material. The elastic hold body 240 can be formed from the same material as that for the outer enclosure 110, for example. Forming the elastic hold body 240 from an elastic foaming body with open cells allows the elastic hold body 240 to have acoustic transmissivity to transmit sounds, and move the air smoothly.

As described above, the elastic hold body 240 has an annular shape and can be attached to the second acoustic transmissive body 260 to circle around the outer periphery of the second acoustic transmissive body 260. The elastic hold body 240 can be provided in a plurality of different positions along the longitudinal direction of the second acoustic transmissive body 260. Pressing the second acoustic transmissive body 260 together with the elastic hold body 240 into the first acoustic transmissive body 160 allows the second acoustic transmissive body 260 to be stored in the first acoustic transmissive body 160.

When the second acoustic transmissive body 260 is stored in the first acoustic transmissive body 160, the elastic hold body 240 elastically deforms to generate biasing force. By the generated biasing force, the second acoustic transmissive body 260 is retained on the first acoustic transmissive body 160.

As described above, the first acoustic transmissive body 160 is retained on the cylindrical portion 114 by the biasing force generated by the elastic deformation of the cylindrical portion 114. In addition, the second acoustic transmissive body 260 is retained on the first acoustic transmissive body 160 by the biasing force generated by the elastic deformation of the elastic hold body 240 attached to the second acoustic transmissive body 260.

Retaining the second acoustic transmissive body 260 on the first acoustic transmissive body 160 makes it possible to prevent deformation and displacement of the second acoustic transmissive body 260 and form the first space SP10 in a stable manner between the first acoustic transmissive body 160 and the second acoustic transmissive body 260.

The elastic hold body 240 is elastically deformable and can absorb external shock. Accordingly, the elastic hold body 240 makes the shock less likely to transfer to the gun microphone 30 and prevent the shock from being picked up as noise. The cylindrical portion 114 first absorbs the shock due to elastic deformation, and then the elastic hold body 240 also absorbs the shock. In this way, it is possible to absorb the shock in the two steps.

### Function of the Second Acoustic Transmissive Body 260

The gun microphone 300 is stored in the second acoustic transmissive body 260. The second acoustic transmissive body 260 has a function of storing and holding the gun microphone 300 in a detachable manner. The second acoustic transmissive body 260 has a cylindrical shape, and the longitudinal length of the second acoustic transmissive body 260 is longer than the longitudinal length of the gun microphone 300. Accordingly, the gun microphone 300 can be smoothly attached to or detached from the second acoustic transmissive body 260, and the entire gun microphone 300 can be stored in the second acoustic transmissive body 260.

The second acoustic transmissive body 260 is composed of an acoustic transmissive member and has a function of preventing wind noise. The second acoustic transmissive body 260 also has a function of holding the gun microphone 300 therein in a detachable manner.

### Third Space SP30

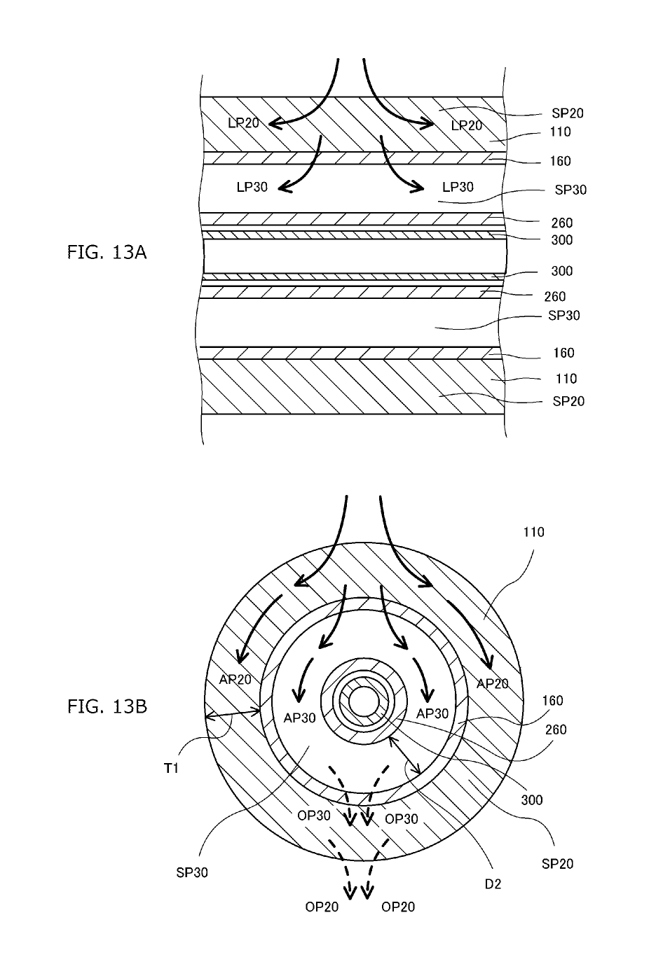

As illustrated in FIGS. 13A and 13B, the first acoustic transmissive body 160 and the second acoustic transmissive body 260 are almost concentric to each other and separated from each other. This makes it possible to define the third space SP30 in a region sandwiched between the first acoustic transmissive body 160 and the second acoustic transmissive body 260. The third space SP30 is an almost cylindrical gap as a whole. The longitudinal length of the third space SP30 is determined by the longitudinal lengths of the first acoustic transmissive body 160 and the second acoustic transmissive body 260. The thickness of side surface of the third space SP30 constitutes a distance between the first acoustic transmissive body 160 and the second acoustic transmissive body 260 (hereinafter, called diametrical thickness D2 of the third space SP30), which is determined by the difference between the radius of the first acoustic transmissive body 160 and the radius of the second acoustic transmissive body 260.

### Second Space SP20

As in the first embodiment, the cylindrical portion 114 of the outer enclosure 110 has a thickness T1 in the radial direction (see FIG. 13B), and the thickness T1 defines the second space SP20. The second space SP20 is an almost cylindrical gap as a whole. The longitudinal length of the second space SP20 is determined by the longitudinal lengths of the cylindrical portion 114 and the first acoustic transmissive body 160. The thickness of side surface of the second space SP20 constitutes the thickness T1 in the radial direction of the cylindrical portion 114 (hereinafter, called diametrical thickness T1 of the second space SP20). The configuration and function of the second space SP20 are the same as those of the first embodiment.

### Flows of Air in the Third Space SP30 (Change in Pressure)

FIG. 13A is a cross-sectional view of flows of air guided along the longitudinal direction in the third space SP30. FIG. 13B is a cross-sectional view of flows of air guided along the circumferential direction (the direction that circles around the first acoustic transmissive body 160) in the third space SP30.

The third space SP30 is a region sandwiched between the first acoustic transmissive body 160 and the second acoustic transmissive body 260. The third space SP30 is not charged with an elastic foaming body, unlike the second space SP20. Depending on the use environment of the gun microphone 300, the third space SP30 may be charged with an elastic foaming body as appropriate.

As described above, the second space SP20 (elastic foaming body) acts as a buffering region for gradually slowing down the air having entered the second space SP20. Therefore, the air is less likely to pass through the second acoustic transmissive body 260. However, depending on the use environment of the gun microphone 300, the air may pass through the second acoustic transmissive body 260. When having passed through the second acoustic transmissive body 260, the air enters the third space SP30.

The third space SP30 is sandwiched between the first acoustic transmissive body 160 and the second acoustic transmissive body 260, and the air having entered the third space SP30 travels while being interfered with by contact with the first acoustic transmissive body 160 and the second acoustic transmissive body 260. In this way, the air having entered the third space SP30 move in the third space SP30 while being attenuated by every contact with the first acoustic transmissive body 160 and the second acoustic transmissive body 260.

As in the second space SP20, the air moving in the third space SP30 has a component LP10 moving along the longitudinal direction of the first acoustic transmissive body 160 and the second acoustic transmissive body 260 (see FIG. 13A) and a component AP10 moving along the circumferential direction of the first acoustic transmissive body 160 and the second acoustic transmissive body 260 (see FIG. 13B).

### Longitudinal Flows of Air in the Third Space SP30

The first acoustic transmissive body 160 and the second acoustic transmissive body 260 have an elongated shape adapted to the gun microphone 300 to cover the gun microphone 300 in the longitudinal direction. Accordingly, the third space SP30 sandwiched between the first acoustic transmissive body 160 and the second acoustic transmissive body 260 also has an elongated and almost cylindrical shape, and the third space SP30 is a space that exists (extends) in the longitudinal direction according to the longitudinal length of the gun microphone 300.

The longitudinal length of the third space SP30 is almost identical to the longitudinal length of the second space SP20. Therefore, for example, the longitudinal (axial) length of the third space SP30 may be almost identical to or slightly larger than the longitudinal length of the gun microphone 300, and can be obtained by adding a length about two to five times the diameter of the gun microphone 300.

The third space SP30 is a region that allows the air to flow in the longitudinal direction, and the air having entered the third space SP30 can move in the longitudinal direction. Specifically, the air having entered the third space SP30 can be guided in the longitudinal direction by the first acoustic transmissive body 160 and the second acoustic transmissive body 260 and gradually slowed down by contact with the first acoustic transmissive body 160 and the second acoustic transmissive body 260. Providing the third space SP30 as the space where the air can move sufficiently in the longitudinal direction increases the opportunities to move and slow down the air gradually, which makes the air less likely to leak from the third space SP30 toward the gun microphone 300.

In this way, the third space SP30 provides a region where the air can flow in the longitudinal direction, and acts as an air flow buffer area to make the air less likely to enter the gun microphone 300.

### Circumferential Flows of Air in the Third Space SP30

The first acoustic transmissive body 160 and the second acoustic transmissive body 260 have an almost cylindrical shape and cover the gun microphone 300 to circle around the gun microphone 300. Accordingly, the third space SP30 sandwiched between the first acoustic transmissive body 160 and the second acoustic transmissive body 260 also has an almost cylindrical shape circling around the gun microphone 300. The third space SP30 is a space that covers the gun microphone 300 in the circumferential direction.

The diametrical thickness D2 of the third space SP30 can be decided depending on the diameter of the gun microphone 300. For example, the diametrical thickness D2 of the third space SP30 can be equal to or smaller than the diameter of the gun microphone 300 or can be equal to or smaller than the radius of the gun microphone 300. In addition, the diametrical thickness D2 of the third space SP30 may be larger than the diameter of the gun microphone 300.

In any case, the third space SP30 only needs to act as an air flow buffer area and provide a space where the air can move sufficiently. Basically, the third space SP30 is preferably configured to provide an almost uniform air layer over the entire perimeter of the gun microphone 300.

Further, the size of the third space SP30 may be decided depending on the size of the second space SP20. For example, when the size of the second space SP20 is significantly larger than the size of the third space SP30, the second space SP20 can keep most of the air having entered the second space SP20 to prevent the air from entering the third space SP30. On the other hand, when the size of the second space SP20 is smaller than the size of the third space SP30, the second space SP20 can keep part of the air having entered the second space SP20 to prevent the air from entering the third space SP30. The size of the third space SP30 and the size of the second space SP20 can be decided according to the use environment of the gun microphone 300 and the structure of the interference tube 320.

The third space SP30 is a region for flowing the air in the circumferential direction, and the air having entered the third space SP30 can move along the circumferential direction. Specifically, the air having entered the third space SP30 can be guided in the circumferential direction by the first acoustic transmissive body 160 and the second acoustic transmissive body 260 and gradually slowed down by contact with the first acoustic transmissive body 160 and the second acoustic transmissive body 260. Providing the third space SP30 as the space where the air can move sufficiently in the circumferential direction increases the opportunities to move and slow down the air gradually, which makes the air less likely to leak from the third space SP30 toward the gun microphone 300.

In this way, the third space SP30 provides a region where the air can flow in the circumferential direction, and acts as an air flow buffer area to make the air less likely to enter the gun microphone 300.

### Flows of Air in the Third Space SP30

As described above, the air having entered the third space SP30 has the component LP10 that moves along the longitudinal direction (see FIG. 13A), and the component AP10 that moves along the circumferential direction (see FIG. 13B). The longitudinal component LP10 and the circumferential component AP10 are determined by the angle and velocity distribution with respect to the second acoustic transmissive body 260 at the time of entry to the third space SP30.

The air of the longitudinal component LP10 moves along the longitudinal direction while being interfered with by the first acoustic transmissive body 160 and the second acoustic transmissive body 260, and is gradually slowed down by the elastic foaming body. The air of the circumferential component AP10 moves along the circumferential direction while being interfered with by the first acoustic transmissive body 160 and the second acoustic transmissive body 260, and is gradually slowed down by the elastic foaming body. In this way, the third space SP30 acts as a buffer area for gradually slowing down the air having entered the third space SP30.

The air having entered the third space SP30 is not only slowed down in the third space SP30 but also may flow in the circumferential direction and then come out from the opposite side of the third space SP30 to the second space SP20 depending on the flow velocity, angle, flow amount, and the like (see arrows OP10 in FIG. 13). The air flowing in the third space SP30 is interfered with by the first acoustic transmissive body 160 and is less likely to leak toward the gun microphone 300.

Wind noise is generated by the air (wind) in direct contact with the diaphragm of the microphone body 310. As described above, first, the second space SP20 (elastic foaming body) suppresses the movement of the air having entered the second space SP20 and then the third space SP30 suppresses the movement of the air having entered the third space SP30. In this way, the third space SP30 and the second space SP20 suppress the movement of the air and make the air less likely to leak toward the gun microphone 300. This blocks the transfer of the air to the diaphragm of the microphone body 310 of the gun microphone 300 and prevents wind noise.

### Suppression of Negative Pressure Fluctuation in the Third Space SP30 and the Second Space SP20

As described above, the air flows into the microphone body 310 of the gun microphone 300 to vibrate the diaphragm and generate wind noise. Further, wind noise is generated not only by the direct inflow of air but also by fluctuation in the surrounding pressure.

Specifically, the air moves around the gun microphone 300 to cause pressure fluctuation, specifically, negative pressure fluctuation. The negative pressure fluctuation may vibrate the diaphragm of the microphone body 310 to generate wind noise. The gun microphone wind shield 100 suppresses such negative pressure fluctuation and prevents the occurrence of wind noise by the negative pressure fluctuation.

First, when the air flows outside the outer enclosure 110 to generate negative pressure fluctuation in the second space SP20, the longitudinal movement of the air and the circumferential movement of the air are generated in the second space SP20 (elastic foaming body) to suppress the negative pressure fluctuation in the second space SP20. Suppressing the negative pressure fluctuation in the second space SP20 makes it possible to prevent the occurrence of negative pressure fluctuation in the first space.

In addition, even when the negative pressure fluctuation in the second space SP20 is transferred to the third space SP30 to cause negative pressure fluctuation in the third space SP30, the longitudinal movement of the air and the circumferential movement of the air are generated in the third space SP30 to suppress the negative pressure fluctuation in the third space SP30 as described above. Suppressing the negative pressure fluctuation in the third space SP30 makes it possible to prevent the transfer of the negative pressure fluctuation to the diaphragm of the gun microphone 300.

Causing proactively the longitudinal movement of the air and the circumferential movement of the air in each of the third space SP30 and the second space SP20 makes it possible to suppress negative pressure fluctuation. The second space SP20 (elastic foaming body) has an elongated shape that can move the air sufficiently in the longitudinal direction. The first acoustic transmissive body 160, the second acoustic transmissive body 260, and the elastic foaming body contact the moving air to slow down the air gradually.

The third space SP30 also has an elongated shape that can move the air sufficiently in the longitudinal direction. The first acoustic transmissive body 160 and the second acoustic transmissive body 260 contact the moving air to slow down the air gradually.

The gun microphone wind shield 100 has the third space SP30 and the second space SP20 to move the air sufficiently in the longitudinal direction and slow down the moving air, thereby absorbing negative pressure fluctuation. In this way, causing the third space SP30 and the second space SP20 to act as two-step buffer areas to suppress negative pressure fluctuation in a stepwise manner.

Accordingly, the gun microphone wind shield 100 has the third space SP30 and the second space SP20 as described above to make the air less likely to enter the gun microphone 300 and prevent wind noise generated from the diaphragm vibrated by the air.

Further, even in the case where the air does not enter the gun microphone 300, the air may flow around the gun microphone 300 to generate negative pressure fluctuation that vibrates the diaphragm. In such a case, the formation of the third space SP30 and the second space SP20 makes it possible to suppress negative pressure fluctuation and prevent the occurrence of wind noise due to the negative pressure fluctuation.

In this way, the third space SP30 and the second space SP20 can not only shut off the movement of the air but also suppress the occurrence of negative pressure fluctuation.

### THIRD EMBODIMENT

In the first embodiment described above, the microphone hold portion 140 formed from metallic frames is used as an example. In a third embodiment, a gun microphone 300 has an elastic hold body 270 to be held directly by an acoustic transmissive body 160. In the third embodiment, the same components as those of the first embodiment are given the same reference signs as those of the first embodiment.

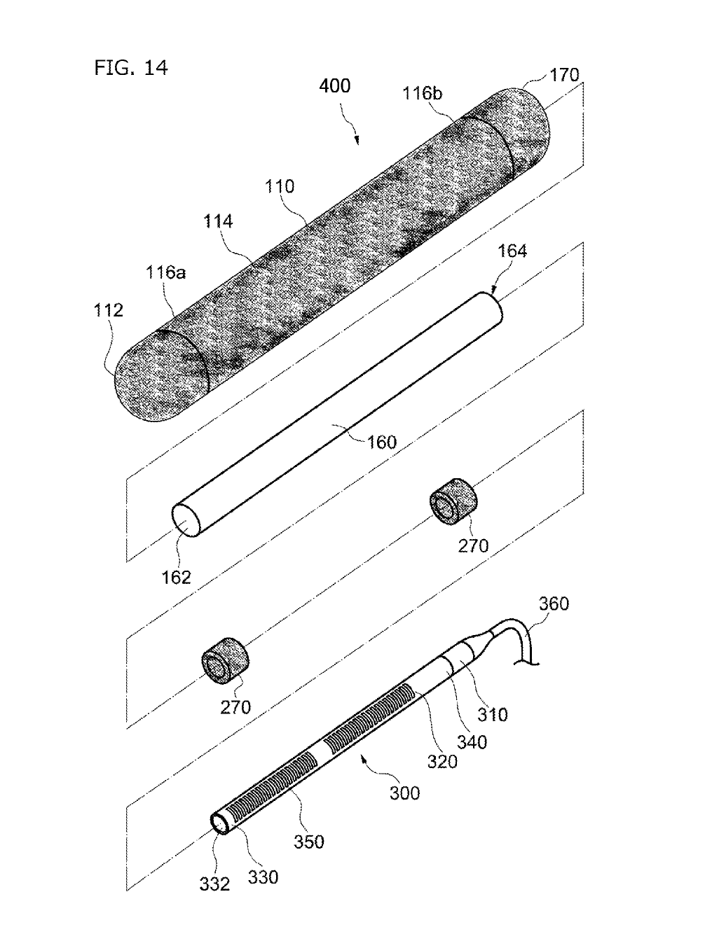

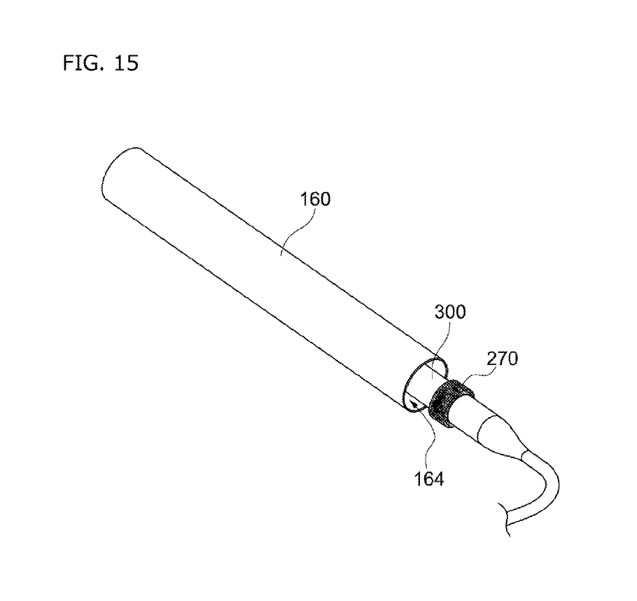

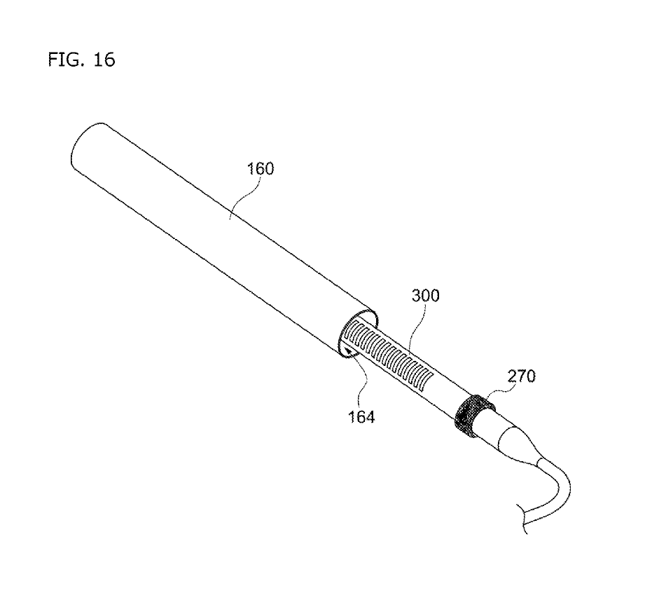

FIG. 14 is a perspective view of a configuration of a gun microphone wind shield 400 according to the third embodiment. FIG. 15 is a perspective view of the acoustic transmissive body 160 and the gun microphone 300 according to the third embodiment. FIG. 16 is a perspective view of the elastic hold body 270 provided between an acoustic transmissive body 160 and the gun microphone 300 according to the third embodiment.

As illustrated in FIG. 14, the gun microphone wind shield 400 in the third embodiment includes mainly an outer enclosure 110, the acoustic transmissive body 160, and the elastic hold body 270.

### Outer Enclosure 110

The outer enclosure 110 has the same configuration and function as those of the gun microphone wind shield 100 in the first embodiment. The outer enclosure 110 has a leading end portion 112 and a cylindrical portion 114. The leading end portion 112 and the cylindrical portion 114 are formed from an elastic foaming body with open cells and have acoustic transmissivity to transmit external sounds.

The outer enclosure 110 is formed from an elastic foaming body and thus is elastically deformable in every portion. Accordingly, even when external shock or the like is applied, the outer enclosure 110 repeats elastic deformation and recovery to absorb the shock gradually. The outer enclosure 110 can constitute a vibration-proof structure. The vibration-proof structure of the outer enclosure 110 absorbs externally applied shock or the like to make the shock less likely to transfer to the gun microphone 300 and prevent the shock from being picked up as noise.

The cylindrical portion 114 has an elongated cavity 118 formed therein along the longitudinal direction. The first acoustic transmissive body 160 can be inserted into the cavity 118. The biasing force generated by the elastic deformation of the cylindrical portion 114 makes it possible to hold the acoustic transmissive body 160 in a constant position in the cavity 118. The first acoustic transmissive body 160 can be held in a constant position in the outer enclosure 110 without having to use a member such as a fixing member.

### Attachment of Vibration-Proof Hold Portion 120 (Hold Body 122 and Grip Portion 130)

In the gun microphone wind shield 400 in the third embodiment as well, the outer enclosure 110 is arranged on the outermost periphery, and the hold body 122 and the grip portion 130 can be detachably attached to the outer enclosure 110 as in the first embodiment. The mode of attaching the hold body 122 to the outer enclosure 110 is the same as that in the gun microphone wind shield 100 in the first embodiment (see FIGS. 1 and 2 and the descriptions thereof).

In this way, the hold body 122 can also be attached to the outer enclosure 110 of the gun microphone wind shield 400 in the third embodiment to retain the annular members 124 on the cylindrical portion 114. This makes it possible to attach the hold body 122 to the outer enclosure 110 without having to process or deform the outer enclosure 110 or change the acoustic characteristics of the outer enclosure 110. In addition, the hold body 122 is detachably configured and thus is easy to carry and handle.

The grip portion 130 is supported by the user's hand, and thus may be subjected to shock during use. The grip portion 130 is attached to the outer enclosure 110 by the annular members 124. As in the first embodiment, the outer enclosure 110 constitutes a vibration-proof structure. Accordingly, even if the grip portion 130 is subjected to shock, the outer enclosure 110 absorbs the shock to prevent the shock from being picked up as noise by the gun microphone 300.

In this way, the grip portion 130 is a member for supporting indirectly the gun microphone 300 via the outer enclosure 110 to make shock or the like less likely to transfer directly to the gun microphone 300.

### Acoustic Transmissive Body 160

The acoustic transmissive body 160 has the same configuration and function as those of the gun microphone wind shield 100 in the first embodiment. The first acoustic transmissive body 160 is formed by curving an almost thin sheet-like acoustic transmissive member into a cylindrical shape. The acoustic transmissive member blocks the passage of part of contacting air. The remaining unblocked air passes through the acoustic transmissive member.

The acoustic transmissive body 160 has an elongated and almost cylindrical shape. The acoustic transmissive body 160 can be inserted into the cavity 118 by slightly elastically deforming the cylindrical portion 114 of the outer enclosure 110, and is retained on the cylindrical portion 114 by the biasing force generated by the elastic deformation of the cylindrical portion 114.

The acoustic transmissive body 160 has a sound source-side end portion 162 blocked with the acoustic transmissive member. This makes the air having flowed into the outer enclosure 110 via the leading end portion 112 less likely to enter the first acoustic transmissive body 160.

### Elastic Hold Body 270

One or more elastic hold bodies 270 are arranged between the acoustic transmissive body 160 and the gun microphone 300. The elastic hold body 270 has a cylindrical shape. The elastic hold body 270 is formed from an elastically deformable material. The elastic hold body 270 is designed so that when the elastic hold body 270 is not deformed, the inner diameter of the elastic hold body 270 is shorter than the diameter of the gun microphone 300. The elastic hold body 270 has a length enough to hold stably the gun microphone 300 on the acoustic transmissive body 160. The elastic hold body 270 can be formed from the same material as that for the outer enclosure 110, for example. Forming the elastic hold body 270 with open cells allows the elastic hold body 270 to have acoustic transmissivity to transmit sounds, and move the air smoothly.

As described above, the elastic hold body 270 has an annular shape and can be attached to the gun microphone 300 to circle around the outer periphery of the gun microphone 300. The elastic hold body 270 can be provided in one or more positions along the longitudinal direction of the acoustic transmissive body 160. Pressing the gun microphone 300 together with the elastic hold body 270 into the acoustic transmissive body 160 allows the microphone 300 to be stored in the acoustic transmissive body 160. As described above, the elastic hold body 270 can transmit sounds but the elastic hold body 270 is preferably arranged so as not to overlap the slits 350 in the gun microphone 300.

When the gun microphone 300 is stored in the acoustic transmissive body 160, the elastic hold body 270 elastically deforms to generate biasing force. By the generated biasing force, the gun microphone 300 is retained on the acoustic transmissive body 160.

As described above, the acoustic transmissive body 160 is retained on the cylindrical portion 114 by the biasing force generated by the elastic deformation of the cylindrical portion 114.

Retaining the gun microphone 300 on the acoustic transmissive body 160 makes it possible to prevent displacement of the gun microphone 300 and form the space SP10 stably between the acoustic transmissive body 160 and the gun microphone 300.

The elastic hold body 270 is elastically deformable and can absorb external shock. Accordingly, the elastic hold body 240 makes the shock less likely to transfer to the gun microphone 300 and prevents the shock from being picked up as noise. The cylindrical portion 114 first absorbs the shock by elastic deformation, and then the elastic hold body 270 also absorbs the shock. In this way, it is possible to absorb the shock in the two steps.

### First Space SP10

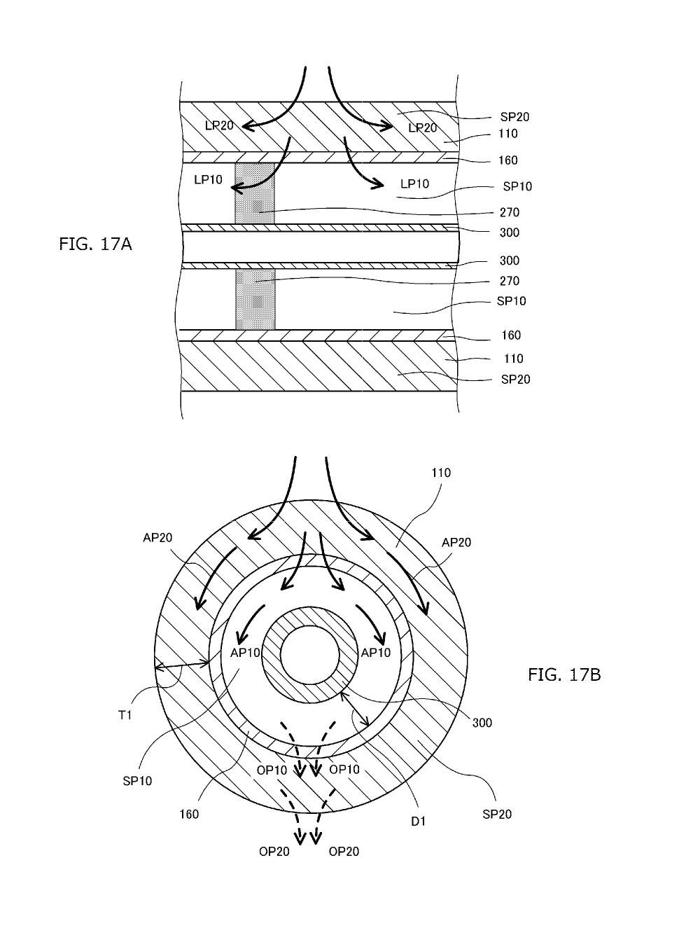

As illustrated in FIGS. 17A and 17B, the acoustic transmissive body 160 and the gun microphone 300 are almost concentric to each other and separated from each other. This forms a region sandwiched between the acoustic transmissive body 160 and the gun microphone 300, which makes it possible to define a plurality of spaces divided by the one or more elastic hold bodies 270 provided on the gun microphone 300. These spaces are obtained by dividing the first space SP10 by the one or more elastic hold bodies 270 provided on the gun microphone 300, which act as the first space SP10 because the elastic hold body 270 can flow smoothly the air.

### Second Space SP20

As in the first embodiment, the cylindrical portion 114 of the outer enclosure 110 has a thickness T1 in the radial direction (see FIG. 1B), and the thickness T1 defines the second space SP20. The second space SP20 is an almost cylindrical gap as a whole. The longitudinal length of the second space SP20 is determined by the longitudinal lengths of the cylindrical portion 114 and the first acoustic transmissive body 160. The thickness of side surface of the second space SP20 constitutes the thickness T1 in the radial direction of the cylindrical portion 114 (hereinafter, called diametrical thickness T1 of the second space SP20). The configuration and function of the second space SP20 are the same as those of the first embodiment.

### Flows of Air in the First Space SP10 (Change in Pressure

FIG. 17A is a cross-sectional view of flows of air guided along the longitudinal direction in the first space SP10. FIG. 17B is a cross-sectional view of flows of air guided along the circumferential direction (the direction that circles around the acoustic transmissive body 160) in the first space SP10.

The first space SP10 is a region sandwiched between the acoustic transmissive body 160 and the gun microphone 300 where the one or more elastic hold bodies 270 exist. The first space SP10 is not charged with an elastic foaming body, unlike the second space SP20. Depending on the use environment of the gun microphone 300, the first space SP10 may be charged with an elastic foaming body as appropriate.

As described above, the second space SP20 (elastic foaming body) acts as a buffering region for gradually slowing down the air having entered the second space SP20. However, the air may enter the first space SP10 depending on the use environment of the gun microphone 300.

The first space SP10 is sandwiched between the first acoustic transmissive body 160 and the gun microphone 300, and the air having entered the first space SP10 travels while being interfered with by contact with the first acoustic transmissive body 160 and the elastic hold body 270. In this way, the air having entered the first space SP10 moves in the first space SP10 while being attenuated by every contact with the first acoustic transmissive body 160 and the elastic hold body 270.

As in the second space SP20, the air moving in the first space SP10 has a component LP10 moving along the longitudinal direction of the first acoustic transmissive body 160 and the gun microphone 300 (see FIG. 17A) and a component AP10 moving along the circumferential direction of the first acoustic transmissive body 160 and the gun microphone 300 (see FIG. 17B).

### Longitudinal Flows of Air in the First Space SP10

The first space SP10 is a space that exists (extends) in the longitudinal direction according to the longitudinal length of the gun microphone 300. The longitudinal length of the first space SP10 can be decided depending on the outer shape of the used gun microphone 300. For example, the longitudinal length of the first space SP10 may be almost identical to or slightly larger than the longitudinal length of the gun microphone 300, and can be obtained by adding a length about two to five times the diameter of the gun microphone 300.

The first space SP10 is a region that allows the air to flow in the longitudinal direction, and the air having entered the first space SP10 can move in the longitudinal direction. Specifically, the air having entered the first space SP10 can be guided in the longitudinal direction by the first acoustic transmissive body 160 and gradually slowed down by contact with the first acoustic transmissive body and the elastic hold body 270.

Providing the first space SP10 as the space where the air can move sufficiently in the longitudinal direction increases the opportunities to move and slow down the air gradually, which makes the air less likely to leak from the first space SP10 toward the gun microphone 300.

In this way, the first space SP10 provides a region where the air can flow in the longitudinal direction, and acts as an air flow buffer area to make the air less likely to enter the gun microphone 300.

### Circumferential Flows of Air in the First Space SP10

The diametrical thickness D1 of the first space SP10 can be decided according to the diameter of the gun microphone 300, but is preferably decided in consideration to the basic function of a wind shield for reducing wind noise and the ease of handling the gun microphone 300. Basically, it is possible to reduce wind noise in lower sound range with increase in D1. For example, the diametrical thickness D1 of the first space SP10 can be equal to or smaller than the diameter of the gun microphone 300 or equal to or smaller than the radius of the gun microphone 300. The diametrical thickness D1 of the first space SP10 may be larger than the diameter of the gun microphone 300.

The first space SP10 only needs to act as an air flow buffer area and provide a space where the air can move sufficiently. The space where the air can move sufficiently can be decided by a balance between the longitudinal length of the first space SP10 and the diametrical thickness D1 of the first space SP10. For example, even when the diametrical thickness D1 of the first space SP10 is shortened, increasing the longitudinal length of the first space SP10 can provide a space where the air can move sufficiently.

The first space SP10 is a region for flowing the air in the circumferential direction, and the air having entered the first space SP10 can move along the circumferential direction. Providing the space where the air can move sufficiently in the circumferential direction as the first space SP10 increases the opportunities to move and slow down the air gradually, which makes the air less likely to leak from the first space SP10 toward the gun microphone 300.

In this way, the first space SP10 provides a region where the air can flow in the circumferential direction, and acts as an air flow buffer area to make the air less likely to enter the gun microphone 300.

### Suppression of Negative Pressure Fluctuation in the First Space SP10 and the Second Space SP20

As described above, the air flows into the microphone body 310 of the gun microphone 300 to vibrate the diaphragm and generate wind noise. Further, wind noise is generated not only by the direct inflow of air but also by fluctuation in the surrounding pressure.

The gun microphone wind shield 400 has the first space SP10 and the second space SP20 to move the air sufficiently in the longitudinal direction and slow down the moving air, thereby absorbing negative pressure fluctuation. In this way, causing the first space SP10 and the second space SP20 to act as two-step buffer areas to suppress negative pressure fluctuation in a stepwise manner.

Accordingly, the gun microphone wind shield 400 has the first space SP10 and the second space SP20 as described above to make the air less likely to enter the gun microphone 300 and prevent wind noise generated from the diaphragm vibrated by the air.

Further, even in the case where the air does not enter the gun microphone 300, the air may flow around the gun microphone 300 to generate negative pressure fluctuation that vibrates the diaphragm. In such a case, the formation of the first space SP10 and the second space SP20 makes it possible to suppress negative pressure fluctuation and prevent the occurrence of wind noise due to the negative pressure fluctuation.

In this way, the first space SP10 and the second space SP20 can not only shut off the movement of the air but also suppress the occurrence of negative pressure fluctuation.

### FIRST MODIFICATION EXAMPLE

In both the first embodiment and the second embodiment described above, the vibration-proof hold portion 120 is retained on the outer enclosure 110. That is, the vibration-proof hold portion 120 is retained on the outer enclosure 110 constituting the outermost peripheral body.

A third acoustic transmissive body may be provided to cover the entirety or peripheral surface of the outer enclosure 110 so that the vibration-proof hold portion 120 is retained on the third acoustic transmissive body as the outermost peripheral body. The third acoustic transmissive body has an elongated and almost cylindrical shape. The diameter of the third acoustic transmissive body is slightly larger than the diameter of the outer enclosure 110. The longitudinal length of the third acoustic transmissive body is larger than the longitudinal length of the outer enclosure 110. The third acoustic transmissive body may have a sound source-side end blocked with an acoustic transmissive member. This makes it possible to prevent inflow of air into the leading end portion 112 of the outer enclosure 110.

The third acoustic transmissive body is formed by curving an almost thin sheet-like acoustic transmissive member into a cylindrical shape, like the first acoustic transmissive body 160 and the second acoustic transmissive body 260. The acoustic transmissive member blocks the passage of part of contacting air. Using an acoustic transmissive member formed by sintering a metallic fiber material makes it possible to enhance water-proof properties.

The annular members 124 of the vibration-proof hold portion 120 are formed according to the shape and properties of the surface of the third acoustic transmissive body so that the annular members 124 can easily catch the third acoustic transmissive body. For example, the roughness of portions of the annular members 124 to contact the surface of the third acoustic transmissive body is preferably decided as appropriate according to the material and roughness of the third acoustic transmissive body. In particular, the annular members 124 are preferably decided according to the cushion property of the third acoustic transmissive body. This improves the engagement between the annular members 124 and the surface of the third acoustic transmissive body, while prevents the engagement from causing a break of the third acoustic transmissive body or the cylindrical portion 114.

Further, since the third acoustic transmissive body is provided to cover the entirety or peripheral surface of the outer enclosure 110, it is possible to protect the outer enclosure 110. As described above, an acoustic transmissive member formed by sintering a metallic fiber material has high water-proof properties to protect the outer enclosure 110 from moisture such as humidity. Specifically, even when the gun microphone wind shields 100 and 200 are used in damp environments with ample rainfall or the like, the third acoustic transmissive body as outermost peripheral body covers the outer enclosure 110 to maintain the characteristics of the outer enclosure 110.

### SECOND MODIFICATION EXAMPLE

A sheet-like wind shield enclosure 180 is provided as outermost peripheral body to cover fully the entire outer surface of the outer enclosure 110. Protecting the outer enclosure 110 from physical shock, ultraviolet rays of the sun, and moisture such as humidity makes it possible to prevent temporal deterioration of the outer enclosure 110. In addition, the sheet-like wind shield enclosure 180 can prevent inflow of air into the wind shield and suppress the entry of dust and the occurrence of noise.

There is no particular limitation on the material for the sheet-like wind shield enclosure 180 but the material is preferably excellent in weather resistance and acoustic transmissivity. For example, such an acoustic transmissive sheet as described above is preferred, and an acoustic transmissive sheet formed from a fiber sheet such as a metallic fiber sheet or a fluorine fiber sheet is more preferred.

There is no particular limitation on the thickness of the sheet-like wind shield enclosure 180. Too large a thickness would make it difficult to fix and seal the sheet-like wind shield enclosure 180, whereas too small a thickness would decrease physical strength. The sheet-like wind shield enclosure 180 is preferably flexible enough to be deformable to cover the outer surface of the outer enclosure 110.

There is no particular limitation on the shape of the sheet-like wind shield enclosure 180 as far as it can fully cover the entire outer surface of the outer enclosure 110. The sheet-like wind shield enclosure 180 has an elongated and almost cylindrical shape adapted to the shape of the outer enclosure 110 and preferably can be brought into a sac-like state.

After the gun microphone wind shield 100 is stored within the sheet-like wind shield enclosure 180, an opening 181 in the sheet-like wind shield enclosure 180 can be closed. There is no particular limitation on the closing means but the opening may be closed by sewing the seam or using an adhesive.

There is no particular limitation on the means for fixing sheet-like wind shield enclosure 180 to the outer enclosure 110, but the outer enclosure 110 and the sheet-like enclosure 180 may be joined to each other by an adhesive, or the sheet-like wind shield enclosure 180 may be tightened externally by the annular members 124 of the vibration-proof hold portion 120.

The outer enclosure 110 and the sheet-like wind shield enclosure 180 may be fixed to each other in close contact with each other, or the outer enclosure 110 and the sheet-like wind shield enclosure 180 may be fixed to each other with a space left therebetween. This space provides a region where the air can flow in the longitudinal direction of the outer enclosure 110, and acts as an air flow buffer area to make the air less likely to enter the gun microphone 300.

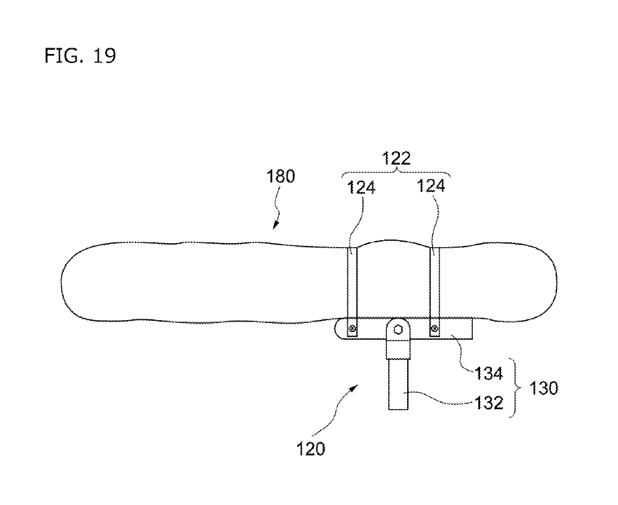

As illustrated in FIG. 19, in the case of providing the sheet-like wind shield enclosure 180, the annular members 124 of the vibration-proof hold portion 120 grip the surface of the sheet-like wind shield enclosure. The annular members 124 are formed to grip easily the sheet-like wind shield enclosure 180 according to the shape and properties of the sheet-like wind shield enclosure 180. For example, portions of the annular members 124 to contact the surface of the sheet-like wind shield enclosure 180 preferably have the roughness decided as appropriate according to the material and roughness of the sheet-like wind shield enclosure. In particular, the annular members 124 are preferably decided according to the cushion property of the outermost peripheral body. This allows the annular members 124 to grip easily the surface of the sheet-like wind shield enclosure and prevents the outer enclosure 110 and the cylindrical portion 114 from being broken when being gripped.

### REFERENCE SIGNS LIST

100 Gun microphone wind shield (gun microphone wind shield 10)
110 Outer enclosure (second covering body 11)
120 Vibration-proof hold portion (hold portion 12)
124 Annular member (surface engagement portion)
130 Grip portion
140 Microphone hold portion (microphone hold body 14)
158 Hold member (hold member 18)
160 First acoustic transmissive body (first covering body 16)
170 Terminal end lid body
180 Sheet-like wind shield enclosure
200 Gun microphone wind shield (gun microphone wind shield 20)
240 Elastic hold body (hold member 24)
260 Second acoustic transmissive body (third covering body 26)
270 Elastic hold body
300 Gun microphone (gun microphone 30)
400 Gun microphone wind shield
SP10 First space (first space SP1)
SP20 Second space (second space SP2)
SP30 Third space (third space SP3)

1. A gun microphone wind shield comprising:
a first covering body that covers a gun microphone, has an elongated shape, and contains an acoustic transmissive material;
a second covering body that covers the first covering body, has an elongated shape, and is formed from an elastic foaming body with open cells; and
a hold portion that engages with the second covering body and is held in a predetermined position on the second covering body,
wherein the acoustic transmissive material includes a fiber material obtained by interlacing a raw material containing fibers.

2. The gun microphone wind shield according to claim 1, wherein the hold portion has a surface engagement portion that engages with the surface of the second covering body.

3. The gun microphone wind shield according to claim 1, wherein the hold portion has a circular engagement portion that circles around the second covering body and engages with the second covering body.

4. The gun microphone wind shield according to claim 1, further comprising a microphone hold body that has an elongated shape, holds the gun microphone in a manner of being capable of sound transmission, is stored in the first covering body, and holds the gun microphone in a position separated from the first covering body,
wherein the first covering body has a storage portion in which the microphone hold body is stored.

5. The gun microphone wind shield according to claim 4, wherein the microphone hold body has a hold member that is elastically deformable by contact with the gun microphone.

6. The gun microphone wind shield according to claim 1, further comprising a third covering body that is capable of holding the gun microphone, has an elongated shape, contains an acoustic transmissive material, is stored in the first covering body, and is held in a position separated from the first covering body.

7. The gun microphone wind shield according to claim 6, further comprising a hold member that holds the third covering body, is arranged between the first covering body and the third covering body, and is formed from an elastic foaming body with open cells.
